(19) United States
(12) Patent Application Publication
(10) Pub. No.: US 2025/0155335 A1
(43) Pub. Date: May 15, 2025

(54) Agricultural Sample Slurry Preparation System and Related Methods

(71) Applicant: Precision Planting LLC, Tremont, IL (US)

(72) Inventors: Kent Levy, Morton, IL (US); Dale M. Koch, Tremont, IL (US)

(21) Appl. No.: 18/838,437

(22) PCT Filed: Jan. 5, 2023
(86) PCT No.: PCT/IB2023/050081

§ 371 Date: Aug. 14, 2024

Related U.S. Application Data
(63) Continuation of application No. PCT/IB2023/050082, filed on Jan. 5, 2023.
(60) Provisional application No. 63/268,418, filed on Feb. 23, 2022.
(60) Provisional application No. 63/268,419, filed on Feb. 23, 2022.
(60) Provisional application No. 63/268,990, filed on Mar. 8, 2022.
(60) Provisional application No. 63/268,418, filed on Feb. 23, 2022.
(60) Provisional application No. 63/268,419, filed on Feb. 23, 2022.
(60) Provisional application No. 63/268,990, filed on Mar. 8, 2022.

(51) Int. Cl. G01N 1/28; G01N 1/34; G01N 1/38

(52) U.S. Cl. CPC G01N 1/286; G01N 1/34; G01N 1/38; G01N 2001/2866

(57) ABSTRACT

A grinder-filter apparatus for preparing an agricultural sample slurry in one embodiment includes a housing defining a grinding chamber, a rotatable paddle disposed in the chamber, a peripheral grinding ring fixedly mounted in the chamber, and a perforated baseplate inside the grinding ring. The grinding ring includes vertically elongated slots each having portions extending above and below the baseplate. The paddle may be formed of a resiliently deformable material. The rotating paddle mixes water and the sample material which may be soil in one embodiment to form the slurry, and forces the slurry into the slots which is deposited in a collection chamber beneath the baseplate. The slots filter out soil particles exceeding a predetermined maximum size as the slurry flows through the slots to the collection chamber. The grinding chamber includes an openable waste door to flush debris out of the chamber between preparing batches of slurry.

### CROSS REFERENCE TO RELATED APPLICATIONS

This application claims priority to U.S. Application Nos. 63/268,418, filed 23 Feb. 2022; 63/268,419, filed 22 Feb. 2022; and 63/268,990, filed 8 Mar. 2022, all of which are incorporated herein by reference in their entireties.

### BACKGROUND

The present disclosure generally relates to agricultural sampling and analysis, and more particularly to a system and associated apparatuses for preparing a slurry from an agricultural material sample such as without limitation soil for subsequent chemical analysis.

Periodic soil testing is an important aspect of the agricultural arts. Test results provide valuable information on the chemical makeup of the soil such as plant-available nutrients and other important properties (e.g., levels of nitrogen, magnesium, phosphorous, potassium, pH, etc.) so that various amendments may be added to the soil to maximize the quality and quantity of crop production.

In some sampling and chemical analysis processes, the raw or bulk agricultural material samples such as soil (or other agricultural materials) extracted from the field may not be suitable for processing in the “as collected” condition in the downstream chemical analysis system. Further sample preparation may therefore be required such as breaking down the larger bulk soil sample into smaller particles, and mixing those particles with water to prepare a sample slurry which can readily flow through the smallest equipment openings in the downstream chemical analysis system without causing plugging problems.

Improvements in agricultural sample preparation for chemical analysis are desired.

### BRIEF SUMMARY

The present disclosure provides an agricultural slurry preparation system comprising a grinder-filter apparatus and related method of use for preparing a sample slurry for chemical analysis from a raw or bulk sample material collected from the agricultural field or farm in some embodiments. The sample material may be a soil sample in some non-limiting embodiments, or other agricultural-related materials described further herein amenable to chemical analysis.

The raw or bulk soil sample is not suitable for processing and analysis in the “as collected” state. Accordingly, the present grinder-filter apparatus provides a complete system which is therefore configured to breakdown the bulk soil into smaller sample particles, mix the sample particles with water to prepare the slurry, and filter/screen or size the particles suspended in the slurry to only pass a predetermined maximum particle size in the slurry to the downstream fluid components for further processing associated with the chemical analysis system. This ensures that the small openings in some of these fluid components will not become plugged by the solid soil particles in the slurry. Advantageously, the grinder-filter apparatus provides all of the foregoing functionality in a compact single enclosed unit with minimal spatial requirements rather than using multiple pieces of equipment and fluid connections to yield the same resultant end product (i.e. sized sample slurry).

The present disclosure further provides an associated system for cleaning the grinder-filter apparatus between of preparing batches of slurry. The cleaning system includes a waste collection apparatus closely coupled and adjacent to the grinder-filter apparatus which cooperates with an openable/closeable waste door which provides access to the grinding chamber of the grinder-filter apparatus. The waste collection apparatus is configured to receive cleaning/flushing water from the grinding chamber exiting through a waste window in the grinder housing which is selectively sealed by the door during normal operation of the grinder-filter apparatus. The waste collection apparatus strains or screens the flushing water to separate entrained debris (e.g., stones, rocks, crop residue, etc.) removed from the grinding chamber with the flushing water, and conveys the screened waste water for suitable disposal.

In one aspect, a grinder-filter apparatus for preparing an agricultural sample slurry comprises: an outer housing defining a vertical centerline and a sealable internal grinding chamber configured to receive agricultural sample material and water; a paddle rotatably disposed in the chamber and operable to mix the sample material and water to form the sample slurry; an annular grinding ring extending circumferentially around a peripheral wall of the grinding chamber, the grinding ring including an array of flow openings spaced circumferentially around the grinding ring; and a baseplate disposed in a lower portion of the grinding chamber inside the grinding ring; wherein the paddle when rotated is operable to force the sample material and water radially outwards into the flow openings of grinding ring, and the flow openings are configured to pass sample material particles of a predetermined size in the slurry into a slurry collection chamber of the apparatus.

In another aspect, a method for preparing an agricultural sample slurry comprises: providing a grinder-filter apparatus comprising a vertical centerline and grinding chamber; adding water and agricultural sample material into the grinding chamber; sealing the grinding chamber; rotating a paddle to mix the water and sample material to form the sample slurry; forcing the sample slurry radially outwards with the paddle; pressing the sample slurry into flow openings in a grinding ring with the paddle, the flow openings being sized to limit a maximum size of sample material particles which can pass into the flow openings to create a sized sample slurry; and passing the sized sample slurry along the flow openings into a slurry collection chamber.

The method may further include slowing the paddle down to a reduced speed, and opening a slurry outlet valve to discharge the sized sample slurry from and empty the slurry collection chamber while rotating the paddle at the reduced speed. The method may further include closing the slurry outlet valve; adding flushing water to the empty slurry collection chamber while the paddle continues to rotate at the reduced speed; opening a waste door coupled to the grinding chamber; and discharging the flushing water and debris remaining in the grinding chamber out through a waste window in the grinding chamber opened by the waste door. The method may further include collecting the flushing water and debris with a waste chute; separating the debris from the flushing water; and discharging the flushing water without debris to waste.

Although the grinder-filter apparatus and related methods or processes for preparing an agricultural sample slurry may be described herein with reference to soil samples for convenience of description, this represents only a single category of use for the disclosed embodiments of the invention. It will therefore be understood that the same apparatus and related methods or processes may be used for processing other types of raw or bulk agricultural related samples including for example without limitation vegetation/plant, forage, manure, feed, or other types of solid or granular sample materials associated with agricultural production. The disclosure herein should therefore be broadly construed as an apparatus and related methods or processes for sizing sample materials and preparing the sample slurry from “as collected” agricultural sample materials regardless of the type of material or method of collection.

### BRIEF DESCRIPTION OF THE DRAWINGS

The present disclosure will become more fully understood from the detailed description and the accompanying drawings, wherein like elements are labeled similarly and in which:

FIG. 1 is a top perspective of an agricultural slurry preparation system according to the present disclosure including a grinder-filter apparatus and associated waste collection apparatus;

FIG. 2 is a bottom perspective view thereof;

FIG. 3 is a top exploded perspective view thereof;

FIG. 4 is a bottom exploded perspective view thereof;

FIG. 5 is a first lateral side view thereof;

FIG. 6 is a second lateral side view thereof;

FIG. 7 is a third lateral side view thereof;

FIG. 8 is a fourth lateral side view thereof;

FIG. 9 is a bottom view thereof;

FIG. 10 is a top view thereof;

FIG. 11 is a side cross sectional view thereof;

FIG. 12 is a first enlarged side cross sectional view thereof showing details of the grinder-filter apparatus;

FIG. 13 is a second enlarged side cross sectional view thereof showing details of the grinding chamber of the grinder-filter apparatus;

FIG. 14 is an enlarged cross-sectional perspective view of the grinding chamber;

FIG. 15 is a top transverse cross sectional view through the grinder-filter apparatus and waste collection apparatus;

FIG. 16 is a top perspective view of the grinding ring and associated perforated baseplate of the grinder-filter apparatus;

FIG. 17 is a bottom perspective view thereof;

FIG. 18 is a top perspective view of the strainer pan and funnel of the waste collection apparatus;

FIG. 19 is a first top perspective view looking inside the grinding chamber;

FIG. 20 is a second top perspective view looking inside the grinding chamber;

FIG. 21 is a top perspective view showing details of the upper portion of the waste collection apparatus;

FIG. 22 is a top exploded perspective view of the waste door assembly and actuator;

FIG. 23 is a top view of a pivotably lid of the grinder-filter apparatus;

FIG. 24 is a partial side cross-sectional view thereof showing the lid closing the grinding chamber and sealed to the top of the grinder-filter apparatus housing; and

FIG. 25A is transverse cross sectional view of an alternative embodiment of a knocker protrusion which is movably mounted to the housing of the grinder-filter apparatus showing the knocker protrusion in a first operating position; and

FIG. 25B is transverse cross sectional view of the alternative embodiment of a knocker protrusion which is movably mounted to the housing of the grinder-filter apparatus showing the knocker protrusion in a second operating position.

All drawings are schematic and not necessarily to scale. Components numbered and appearing in one figure but appearing un-numbered in other figures are the same components unless expressly noted otherwise. Any reference herein to a figure by a whole figure number which may appear in multiple figures bearing the same whole number prefix but with different alphabetical suffixes shall be construed as a general reference to all of those figures unless expressly noted otherwise.

### DETAILED DESCRIPTION

The features and benefits of the present disclosure are illustrated and described herein by reference to exemplary (“example”) embodiments. This description of exemplary embodiments is intended to be read in connection with the accompanying drawings, which are to be considered part of the entire written description. Accordingly, the disclosure expressly should not be limited to such exemplary embodiments illustrating some possible non-limiting combination of features that may exist alone or in other combinations of features.

In the description of embodiments disclosed herein, any reference to direction or orientation is merely intended for convenience of description and is not intended in any way to limit the scope of the present disclosure. Relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

As used throughout, any ranges disclosed herein are used as shorthand for describing each and every value that is within the range. Any value within the range can be selected as the terminus of the range. In addition, all references cited herein to prior patents or patent applications are hereby incorporated by reference in their entireties. In the event of a conflict in a definition in the present disclosure and that of a cited reference, the present disclosure controls.

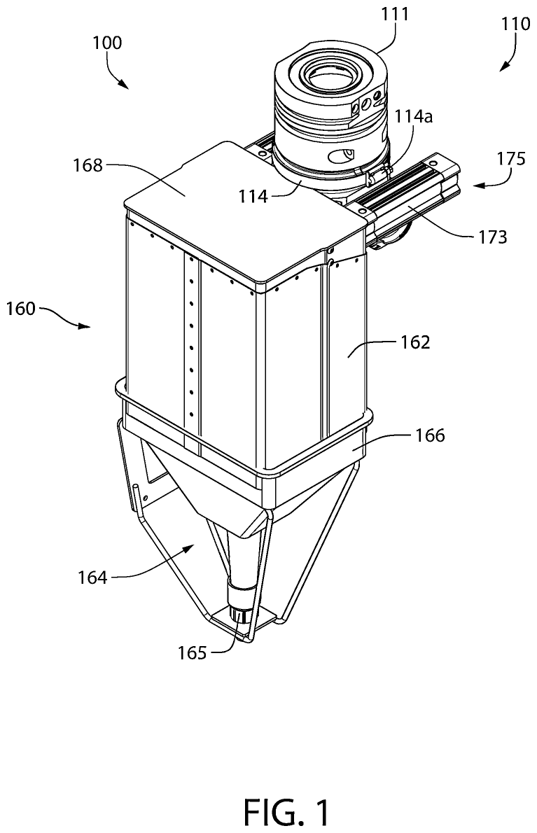

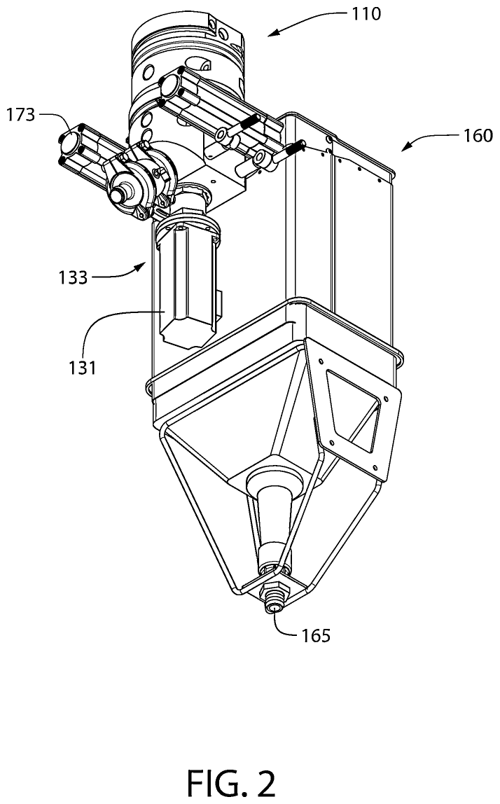

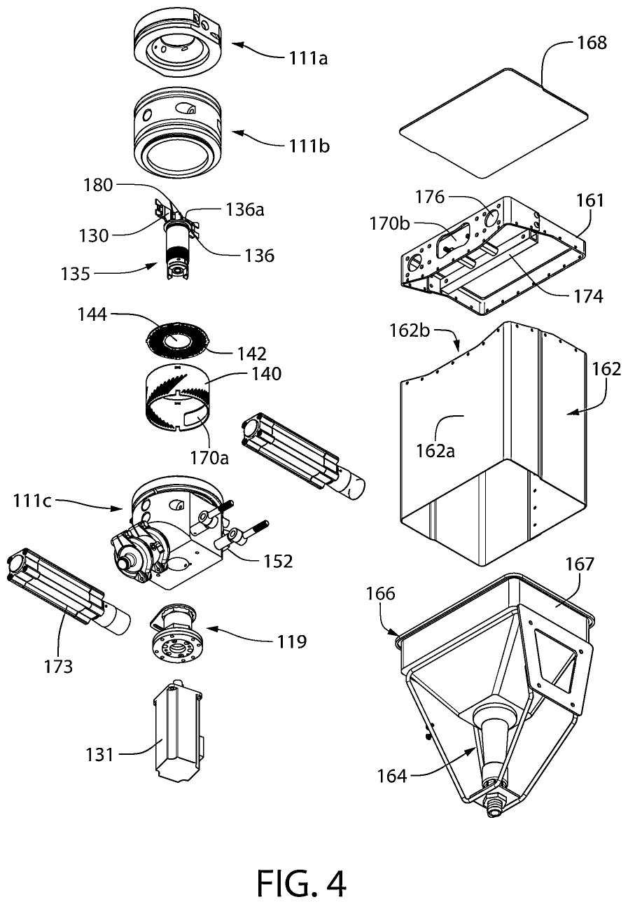

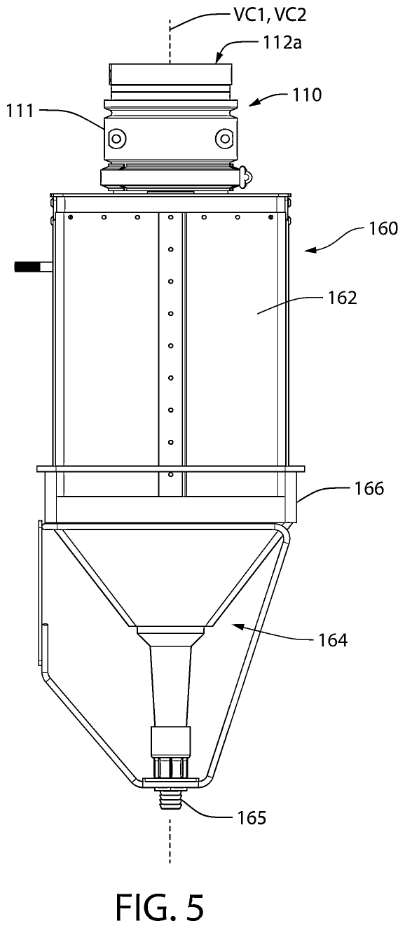

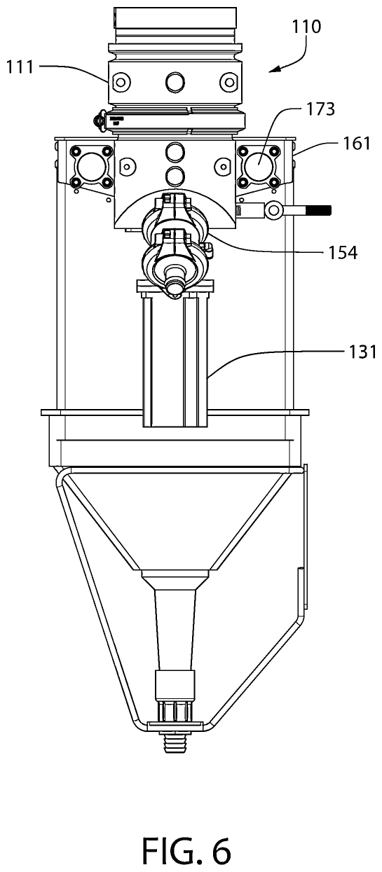

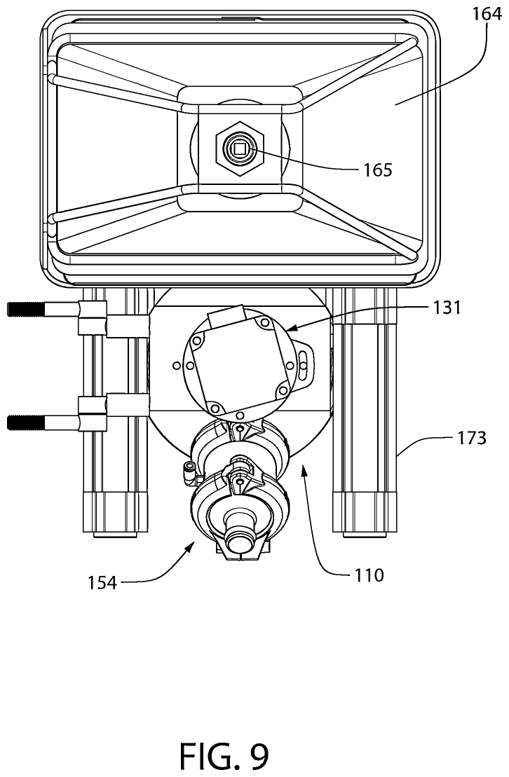

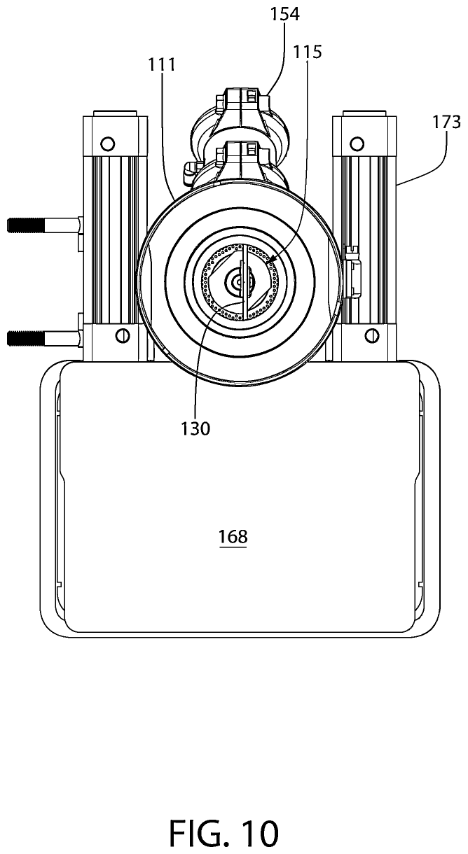

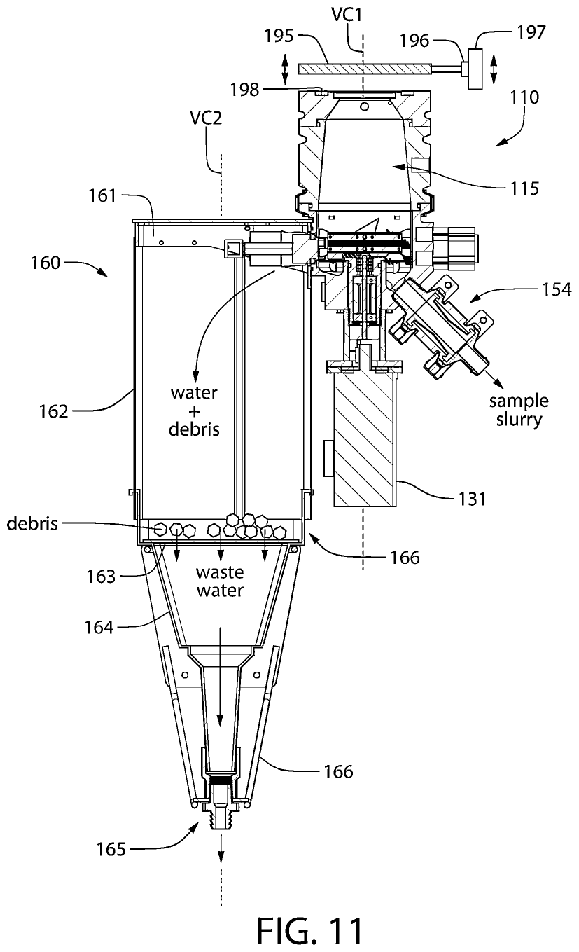

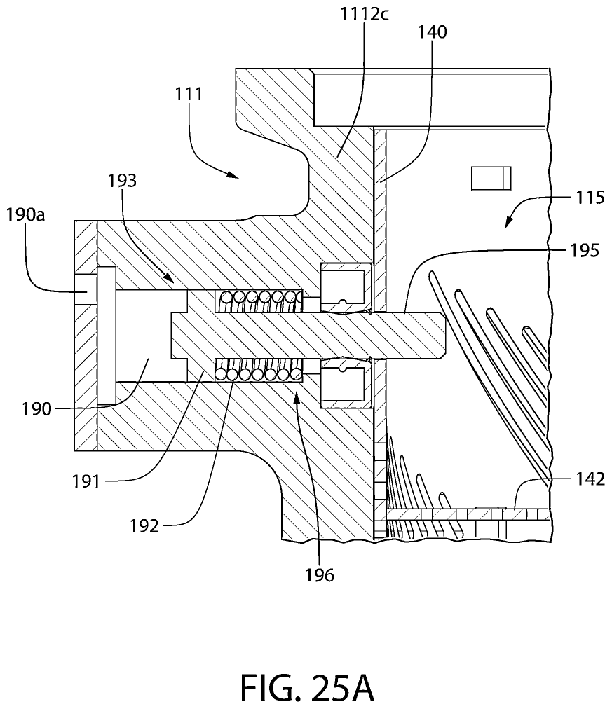

FIGS. 1-24 show one embodiment of an agricultural sample slurry preparation system 100 and various components thereof according to the present disclosure. The slurry preparation system is advantageously configured to (1) mix the raw or bulk sample solids with water to form the sample slurry, break down the sample solids into smaller size particles, and filter or screen the slurry to filter out particles exceeding a predetermined maximum size. Slurry preparation system 100 will be described below for convenience of reference to processing soil samples as one possible but not limiting illustrative use. The system however may be used to prepare and size slurries for other types of agricultural and/or farm related sample materials, as previously described herein.

Sample slurry preparation system 100 in one embodiment generally comprises a grinder-filter apparatus 110 and an associated waste collection apparatus 160 closely coupled to the grinder-filter apparatus. Collection apparatus 160 may be physically coupled to and supported in part by the grinder-filter apparatus in one embodiment, or completely self supported. The waste collection apparatus is positioned and configured to receive an aqueous solution of debris solids and cleaning or flushing water ejected from the grinder-filter apparatus when cleaning out the grinder-filter apparatus between processing batches of slurry. Both the grinder-filter apparatus and debris collection apparatus will be further described in turn below.

Grinder-filter apparatus 110 comprises an outer housing 111 defining a vertical centerline VC1, openable top 112a, closed bottom 112b, lateral sidewall 112c, and a grinding chamber 115 extending between the top and bottom. Housing 111 may be considered generally cylindrical in some embodiments as shown; however, other non-polygonal or polygonal shaped housing configurations may be used.

In some embodiments, the housing 111 may have a monolithic unitary or one-piece construction. However, in the non-limiting illustrated embodiment, housing 111 may be collectively formed by various sections detachably coupled and sealed together to provide ready access to the grinding chamber 115 for periodic disassembly and maintenance of the grinder-filter apparatus 110 as needed when the grinding chamber flushing process described herein may not be entirely adequate. The segmented embodiment of housing 111 may include an upper section 111a, intermediate section 111b, and lower section 111c which are detachably coupled together by any suitable mechanical joinder method known in the art. For example, fasteners such as without limitation circular tightenable/compressible flange or band clamps 114 with threaded operators 113a (i.e. screws) or toggle operators (not shown) may be used to detachably couple the housing sections together in a preferably water-tight and sealable manner to contain the water-based sample slurry in the grinding chamber 115 without leakage. Commercially-available O-ring seals 113 may be used between the housing sections to enhance the water-tight seal. It bears noting that the grinding chamber 115 is collectively defined by the top, intermediate, and lower sections 111a-111c of the housing.

The interior surface 111d of the sidewall 112c of housing 111 (collectively formed by the sidewall of housing sections 111a-111c) defines an internal peripheral wall 116 which defines and surrounds the internal grinding chamber 115 and its cross-sectional shape. Sidewall 112c and concomitantly peripheral wall 116 of the grinding chamber may be arcuately curved in one embodiment. Grinding chamber 115 may extend vertically for a majority of the height of housing 111 from the top 112a of the housing downwards through upper and intermediate sections 111a, 111b and at least partially into the bottom section 111c of the housing. The upper housing section 111a defines a central opening 117 through which water and the raw or bulk sample material in the “as collected” condition from the field and/or farm may be introduced into the grinding chamber 115 for processing, as further described herein.

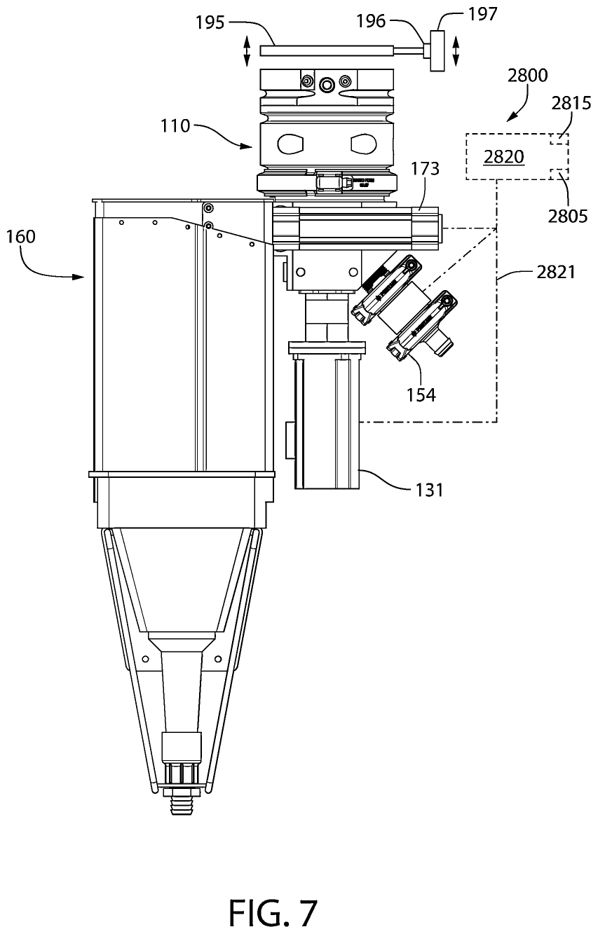

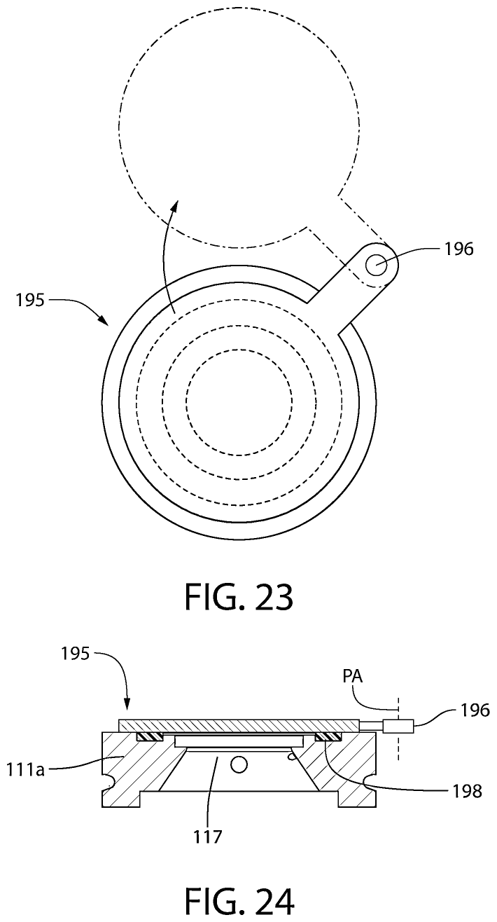

Grinder-filter apparatus 110 further includes a movable lid 195 which can be selectively and detachably engaged with upper housing section 111a to close or open the central opening 117 to provide access to the grinding chamber 115 (see, e.g., FIGS. 7, 11, and 23-24). In one embodiment, lid 195 may be both pivotably and vertically movable. Lid 195 may have a flattened and broadened metallic plate body coupled on one side to hinge 196 which defines a lid pivot axis PA. The lid is laterally rotatable in an arcuate path between an inward position over the central opening 117 in the top 112a of grinder housing 111, and an outward position laterally displaced therefrom (see, e.g., FIG. 23). When the lid is in the outward position, the water and sample materials (e.g., soil) can be added to the grinding chamber 115. The lid can then be returned inward to position it over the central opening for sealing to the grinder housing 111.

The hinge 196 in one embodiment may be fixedly coupled to a vertically movable support member 197 which is movable upwards and downwards with the hinge relative to the grinder-filter apparatus housing 111 which remains stationary. To seal the grinding chamber 115 when the lid 195 is in its inward position described above, the lid is lowered onto and engages the grinder housing 111 via downward movement of support member 197. The lid compresses an annular seal 198 positioned around the central opening 117 on housing upper section 111a which provides a liquid-tight seal for processing a batch of slurry in grinder-filter apparatus 110.

With continuing general reference back now to FIGS. 1-24, the grinding chamber 115 in some implementations may have a generally frustoconical cross-sectional shape at least in part as shown which widens in diameter moving from top 112a towards the bottom 112c of the housing 111. For example, the upper and middle portions 115a, 115b of the grinding chamber defined by upper and middle sections 111a, 111b respectively of housing 111 may each be frustoconical shaped, with the same or different frustoconical shapes in angle relative to vertical centerline VC1 as shown. The peripheral wall 116 of grinding chamber 115 collectively defined by the housing sidewalls 112c in upper, intermediate, and lower housing sections 111a, 111b, and 111c concomitantly forms the cross-sectional shape of the chamber. In one embodiment, the portion of the housing sidewall 112c in the lower portion 115c of grinding chamber 115 in housing lower section 111c may preferably be vertically straight, thereby defining a corresponding straight peripheral wall 116 in this section parallel with vertical centerline VC1 having constant diameter from top to bottom of the lower section. The housing lower section 111c contains the rotating paddle 130 and grinding blade 118. Therefore, this portion of the grinding chamber preferably has a straight cylindrical peripheral wall 116 to facilitate breaking down and sizing/screening the soil sample, as further described herein.

It bears noting that use of the frustoconical portions of the grinding chamber 115 and sidewalls 112c of housing sections 111a and 111b aids in returning and guiding the slurry downwards when agitated by paddle 130 and grinding blade 118 more readily to thoroughly blend or mix the water and soil solids in an efficient manner.

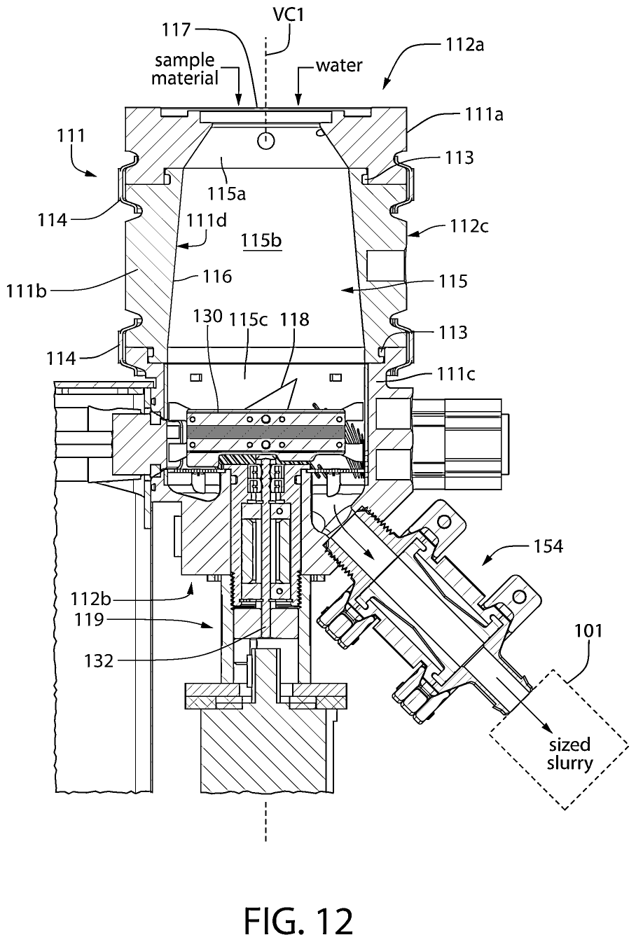

Referring to FIGS. 12-20, the grinder-filter apparatus 110 further includes sleeve-like annular grinding ring 140, horizontal baseplate 142, and slurry collection chamber 150. Baseplate preferably may be perforated; however, a solid baseplate may alternatively be used. Grinding ring 140 is vertically oriented as shown and has a tubular hollow cylindrical body defining a circular sidewall 140a producing a corresponding circular cross sectional shape and vertically-extending passage inside. Grinding ring 140 may be formed of a preferably corrosion-resistant metallic material (e.g., aluminum, stainless steel, or other) to better resist abrasive wear by the soil particle or debris entrained in the raw or bulk unprocessed sample material (e.g., stones, rocks, etc.) when compared to softer materials such as polymers.

Grinding ring 140 extends circumferentially around peripheral wall 116 of the grinding chamber 115. In one embodiment, the grinding ring is fixedly mounted in the housing 111 (e.g., lower section 111c) such that the cylindrical sidewall 140a of the ring abuts directly against the peripheral wall 116 of the grinding chamber 115. The chamber peripheral wall 116 therefore provides lateral or radial support to the grinding ring and acts as a structural backing member to resist the radial or centrifugal fluid forces against the ring imposed by the slurry when agitated by paddle 130. The radial thickness of the grinding ring also determines the depth of the slots 114a in part and sizing of the particles.

Grinding ring 140 comprises a plurality or array of flow openings 141 spaced circumferentially around the body of the grinding ring. The flow openings 141 are configured to receive the sample slurry (i.e. water and soil particles suspended therein), and transfer and deposit the slurry into slideably collection chamber 150. The flow openings 141 are configured (e.g., shape and size) to function as a screen or filter which sets and limits the maximum size soil particle which can pass into the grinding ring flow openings and flow into the slurry collection chamber 150 for final discharge from the grinder-filter apparatus 110 to the downstream chemical analysis system 101.

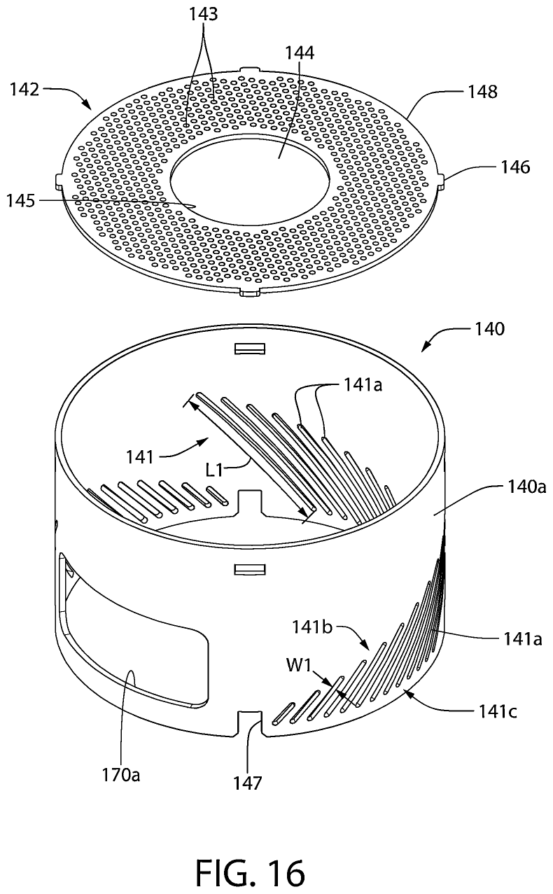

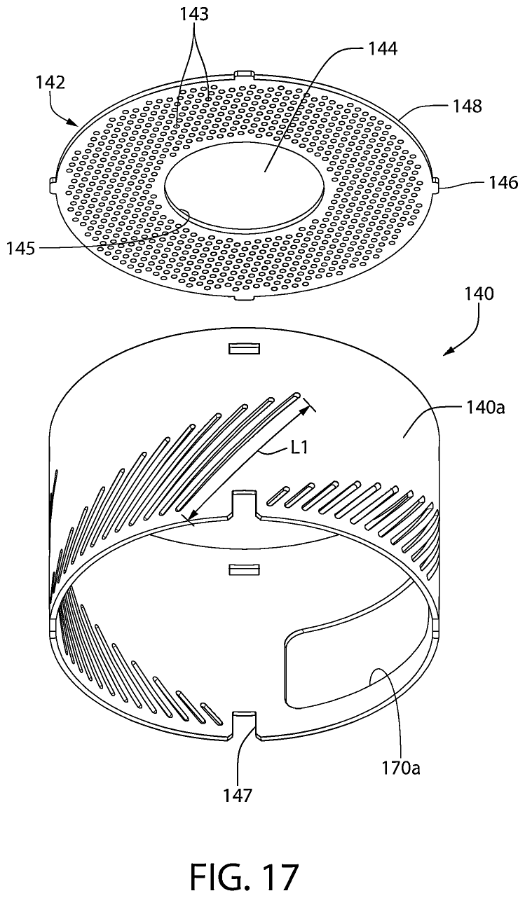

In one embodiment, flow openings 141 of grinding ring 140 may be configured as a plurality of vertically elongated flow slots 141 a each extending both vertically above the perforated baseplate 142 into the grinding chamber 115 at top, and below the baseplate into the slurry collection chamber 150 at bottom; the collection chamber in this embodiment being formed in housing lower section 111c directly beneath and adjacent to the baseplate. Accordingly, each slot has a continuous length L1 (measured in the vertical direction along and not transversely through the grinding ring sidewall 140a as shown in FIGS. 16-17) which includes an upper portion 141b located inside the grinding chamber and a contiguous lower portion 141c located inside the collection chamber.

The flow slots 141a each form flow passages of predetermined size through which the slurry with entrained soil particles forced radially outwards by the rotating paddle 130 enters and flows in a downwards direction into the slurry collection chamber 150. The dimensions or size (i.e. width W1—FIG. 16) of the slots 141a is preselected to receive and convey only soil particles not exceeding a predetermined maximize particle size (or other sample material) which can be tolerated by the smallest fluid component size opening in the downstream chemical analysis system 101 in order to prevent equipment plugging problems. In other words, soil particles of a size exceeding the preselected slot dimension or size (width W1) of slots 141a cannot enter the slot and flow with the sized sample slurry to the slurry collection chamber 150. The grinding ring 140 therefore acts a filter or screening device which is configured to limit the maximum soil particle size in the final sized sample slurry defined as the slurry after being filtered by the grinding ring 140.

It bears noting that the slots 141a may extend completely through the cylindrical sidewall 140a of the grinding ring 140 in some embodiments. However, because there is no appreciable space or gap between the grinding ring and chamber peripheral wall 116 due to their abutting relationship as explained above, the soil particles in the sample slurry cannot pass transversely or radially through the slots in sidewall 140a of the ring. Accordingly, soil particles suspended in the slurry can only enter the slots 141a and flow downwards along their length L1 into the slurry collection chamber 150 below. The slots may also extend only partially through the ring sidewall 140a in other constructions to act as grooves which receive and guide the slurry to the collection chamber.

In yet other embodiments, an annular space may be provided between the grinding ring 140 and peripheral wall 116 of grinding chamber 115 to allow the slurry with “sized” solid particles to flow transversely through the grinding ring sidewall 140a into the space and then downwards into slurry collection chamber 150. In such a construction, the initial flow through the slots is perpendicular or transverse to grinder-filter apparatus vertical centerline VC1 and then downwards parallel to the centerline.

In one embodiment, the slots 141a may comprise a plurality of different lengths L1 as shown to facilitate capture and screening of the soil particles in the slurry (see, e.g., FIGS. 16-17). In other embodiments, the slots may have a uniform length. The slots may be grouped in clusters of slots arranged on the cylindrical sidewall 140a of grinding ring 140 in some embodiments; each cluster being spaced circumferentially apparat around the grinding ring 140 as shown. Each slot in a cluster may have a different or the same length. In other embodiments, the slots may be uniformed spaced circumferentially around the grinding ring 140 and not clustered. In one embodiment, the slots 141a may further be angled in a direction of rotation of the paddle 130 (i.e. at an acute angle to vertical centerline VC1) to facilitate entry of the slurry and soil particles into and along the slots into the collection chamber below. In other embodiments, slots 141a may be vertical and oriented parallel to centerline VC1.

It bears noting as stated above that because the grinding ring 140 in the illustrated embodiment is abutted against the chamber peripheral wall 116, the through slots 141a do not permit slurry or soil particles to pass radially outwards behind the grinding ring. The only path the slurry can take is downwards along and in the slots into the slurry collection chamber 150.

With continuing reference to FIGS. 12-20, perforated baseplate 142 may be a flat and circular corrosion-resistant metallic plate of annular shape in one embodiment defining a central opening 144. The baseplate is mounted to housing 111 of grinder-filter apparatus 110 and disposed inside the grinding ring 140. Baseplate 142 is preferably mounted near, but spaced slightly upward and apart from the bottom end of grinding ring 140. This allows a portion of the grinding ring and every slot 141a therein to extend below baseplate into the slurry collection chamber 150 as shown. The circumferential edge of baseplate 142 terminates adjacent and proximate to the inside of the grinding ring as shown so there are no appreciable gaps for solids or particles of sample material (e.g., soil) suspended in the slurry to bypass the grinding ring 140 and enter slurry collection chamber 150 other than by flowing through the slots 141a in the grind ring.

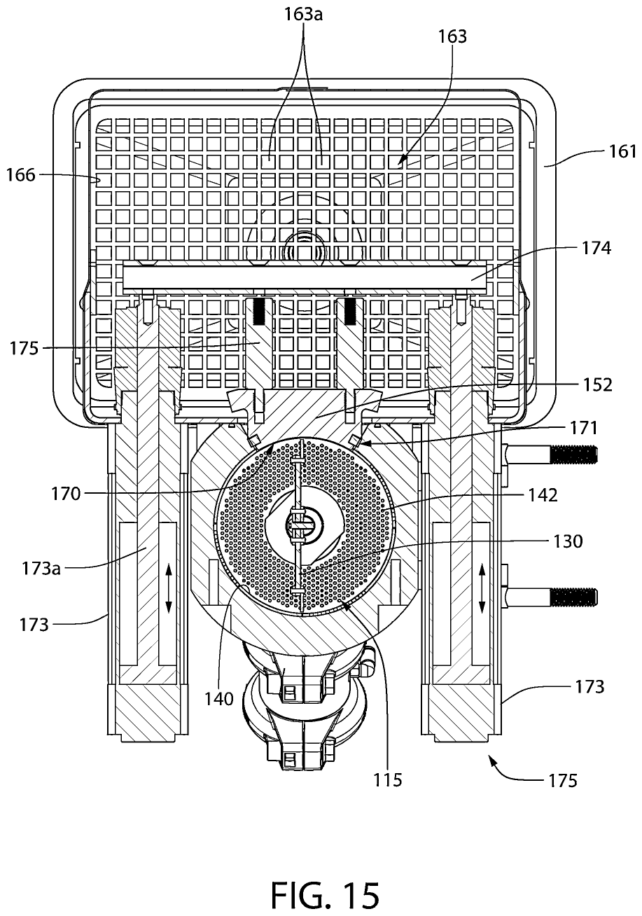

Perforated baseplate 142 includes a plurality of perforations 143 extending vertically and completely through the baseplate from top to bottom between the slurry collection chamber 150 and the grinding chamber 115. Collection chamber 150 is thus in fluid communication with the grinding chamber through the perforations 143, in addition to through the through slots 141a in the grinding ring 140 previously described herein. The perforations may cover a majority of the surface area of the baseplate, and in some embodiments as much as 90 percent or more of the surface area (see, e.g., FIGS. 15-17). The perforations 143 are complementary sized to the grinding ring slots 141a to meet the same maximum allowable particle size limit established for the grinder-filter apparatus 110. Therefore, only soil sample particle sizes meeting the maximum size (e.g., diameter) criteria of the slots may pass directly into collection chamber 150 from grinding chamber 115 through the perforations 143. In operation, due to the radial circumferential and radially outward forces imparted to the slurry by the rotating paddle 130, only a small amount of slurry might possibly pass downward through the perforations in baseplate 142 directly to the slurry collection chamber. Instead, the perforations 143 contribute to forming a recirculation path for some of the sized slurry in collection chamber 150 to flow upward and re-enter the un-sized slurry in the grinding chamber 115. This recirculating slurry flow provided by the perforated baseplate option with sized soil particulate matter advantageously helps the paddle 130 to thoroughly mix and agitate the slurry already in the grinding chamber until most of the soil sample material circulating through the grinding chamber with the water eventually has been reduced in size to meet the maximum particle size criteria or limit necessary for discharge downstream to the downstream chemical analysis system 101. In other embodiments where recirculating slurry flow may not be desired or needed, the baseplate may be solid in structure without perforations as previously noted.

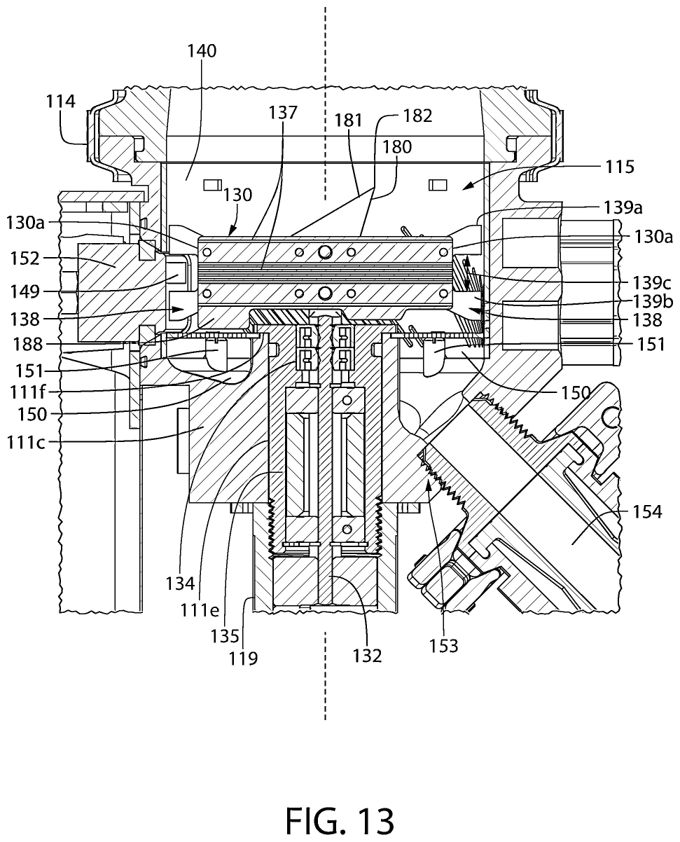

The slurry collection chamber 150 may have an annular shape in some embodiments as shown. The chamber also has a bottom which may be sloped towards slurry outlet 153 to facilitate urging the slurry towards the outlet when the grinder-filter apparatus 110 is emptied. Chamber 150 is formed in housing lower section 111c surrounding the tubular bearing housing 135 associated with paddle 130 and its drive motor 131. The annular shape of baseplate 142 with central opening 144 allows the baseplate to slide over the top of bearing housing 135 in the grinding chamber 115. In one embodiment, the baseplate 142 may be supported at least in part by a plurality of vertically-extending standoffs 151 located in and founded on the floor of the slurry collection chamber 150 (see, e.g., FIG. 13). The baseplate may further be supported by and locked into the grinding chamber 115 by the annular flange 136 of the bearing housing, which traps the inner portion or edge 145 of the baseplate between the flange and top surface 111f of housing lower section 111c inside the lower portion of grinding chamber 115.

The outer portion or edge 148 of baseplate 142 may be secured to grinding ring 140 by a plurality of outwardly protruding radial tabs 146 received in mating slots 147 formed in the bottom of the grinding ring (see also FIG. 16-17). Accordingly, both the inner and outer edges 145 and 148 of baseplate 142 are rigidly secured inside grinding chamber 115 to resist the agitated water and soil material mixture when paddle 130 is in operation. It bears noting therefore that the baseplate may engage but need not necessarily be fastened to the standoffs 151 which support and prevents the baseplate from bending and flexing during operation of grinder-filter apparatus. In some embodiments, the standoffs may be omitted if the baseplate is of sufficient thickness and rigidity in structure itself. In yet other embodiments, the baseplate 142 may be rigidly coupled to the standoffs 151.

The rotatable paddle assembly 133 of grinder-filter apparatus 110 operates for mixing the water and soil sample material to prepare the sample slurry, and provides the agitation necessary for breaking down agricultural material solids (e.g., soil) into smaller size particles. The paddle assembly further provides the motive radial force to drive the soil particulates in the slurry through the slots 141a of the grinding ring 140. In doing so, the soil particles are filtered and sized to limit the maximum particle size (e.g., diameter) of the soil particles (or other agricultural material in other embodiments) entrained in the slurry which are allowed to pass into slots 141a of grinding ring 140, and flow into slurry collection chamber 150 and the downstream chemical analysis system 101 (schematically depicted in FIG. 12 by dashed lines).

In one embodiment, the paddle assembly 133 comprises paddle 130 which is rotatably disposed in grinding chamber 115. Paddle 130 is operably coupled to an electric drive motor 131 via its drive shaft 132. The motor and drive shaft may be vertically oriented in one embodiment. The motor rotates the drive shaft, which in turn rotates the paddle. Any suitable commercially-available electric motor may be used. In one embodiment, a variable speed drive motor 131 may be used to allow the rotational speed of the paddle 130 to be varied during the slurry preparation process and cleanout of the grinding chamber 115 between slurry preparation cycles. Other commercially-available means of varying the speed of the motor drive shaft such as speed control units or geared drives used in conjunction with a fixed speed motor may be used to vary the speed of the motor drive shaft.

In one embodiment, the paddle drive motor 131 may be supported from lower section 111c of housing 111 of grinder-filter apparatus 110 by a tubular motor support 119 mounted to the bottom of the housing at one end, and to the motor at the opposite end (see, e.g., FIG. 12). Motor support 119 may be flanged at each of the top and bottom ends for mounting the support to the housing and motor with threaded fasteners such as screws (not shown but well known in the art). The motor is thus supported from above in a suspended manner from housing 111.

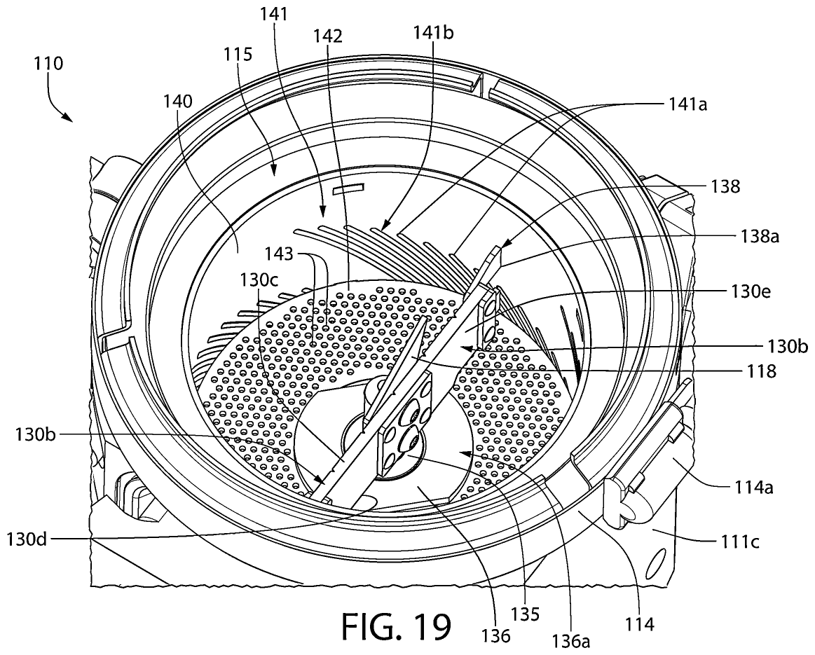

The vertically oriented motor drive shaft 132 is laterally supported and guided by bearings 134 mounted in a tubular bearing housing 135 mounted to lower section 111c of housing 111 (best shown in FIG. 13). Drive shaft 132 extends vertically through bearing housing 135 and tubular motor support 119 and is fixedly coupled to paddle 130 at the top of the shaft. Shaft seals (not shown) prevent seepage of liquid from the slurry chamber 150 along the drive shaft. Housing lower section 111c defines a vertically elongated circular bore 111e through which the corresponding vertically elongated bearing housing extends. The top end of bearing housing 135 in one embodiment includes a radially protruding annular flange 136 which is seated on a corresponding top surface 111f of housing lower section 111c inside the lower portion of grinding chamber 115. Flange 136 defines an upward facing flat surface 136a which is exposed to chamber 115 (see also FIG. 19).

Paddle 130 is rotatably disposed in the lower portion 115c of the grinding chamber 115 and operable to mix the sample material and water to form the sample slurry. In one embodiment, paddle 130 is horizontally/radially elongated in a direction transverse to the vertical centerline VC1 of the grinder-filter apparatus 110 and comprises opposing ends 130a each of which terminate proximate to the grinding ring 140 in grinding chamber 115, as further described herein. Paddle 130 in one embodiment may have a generally flattened body 130e of rectangular form defining opposing parallel and flat major sides 130b, a straight top edge 130c, and straight bottom edge 130d.

In one embodiment, the body 130e of paddle 130 may be formed of a resiliently deformable material which is deflectable/bendable about the vertical centerline VC1 of grinder-filter apparatus 110. Elastomeric materials such as natural rubber and synthetic polymeric elastomer materials may be used. Advantageously, the deformable paddle 130 allows the paddle to deform while spinning at high rates of speed (RPM-revolutions per minute) when encountering hard objects or debris in grinding chamber 115 which may sometimes be entrained in the bulk soil sample (e.g., rocks, stones, etc.) without damaging the paddle. This allows the grinder-filter apparatus to continue operation and formation of the sample slurry when hard debris is encountered by the paddle which cannot be broken down in size. The debris can then be removed later from grinding chamber 115 without disruption of the slurry preparation process when the grinding chamber is cleaned, as further described herein.

Since the paddle 130, made from a flexible material, may be rotated at high speeds (RPMs) to prepare the slurry, the length of the paddle (measured horizontally perpendicularly to vertical centerline VC1) may tend to elongate in the horizontal or radial direction which might forcibly contact the grinding ring and slow down the paddle, thereby adversely affecting its operation. To combat this problem, the body 130e of paddle 130 is some embodiments may be structurally reinforced with cording fiber strands 137 embedded in the elastomeric paddle (see, e.g., FIG. 13). The strands 137 of cording fiber may each linearly extend radially/horizontally from and between the terminal ends 130a of the paddle and operate to limit radial or horizontal elongation of the deformable paddle body when rotated at high RPMs. In one non-limiting embodiment, cording fiber strands 137 may be made of Kevlar® cords; however, other suitable cording material with suitable tensile strength may be used which limit the elongation of the paddle when rotated.

Each of the two opposing terminal ends 130a of the paddle 130 in a preferred but non-limiting embodiment is fitted with a rigid and flattened metallic end plate 138. The end plates are vertically oriented and each defines a vertical edge 138a which travels along and adjacent to the grinding ring 140 when the paddle is rotated to push the slurry and sample solids or particles into the open slots 141a of the grinding ring 140. Advantageously, the end plates being formed of metal as opposed to the flexible elastomeric of the main paddle body 130e are able to withstand abrasion better as the end plates sweep along the grinding ring 140 and positively force the slurry and solid soil particles through the ring into the slurry collection chamber 150. The end plates 138 further act to shear and break up clumps of the sample material solids (e.g., soil) as the clumps are pressed against the grinding ring 140 by the end plates.

The end plates 138 may be fixedly coupled to the paddle body by any suitable fastening technique known in the art such as rivets, pins, or threaded fasteners as some non-limiting examples. Other suitable fastening means known in the art however may be used which can provide fixed connection that can withstand the rotational forces of the paddle 130 without dislodging the end plates 138 therefrom.

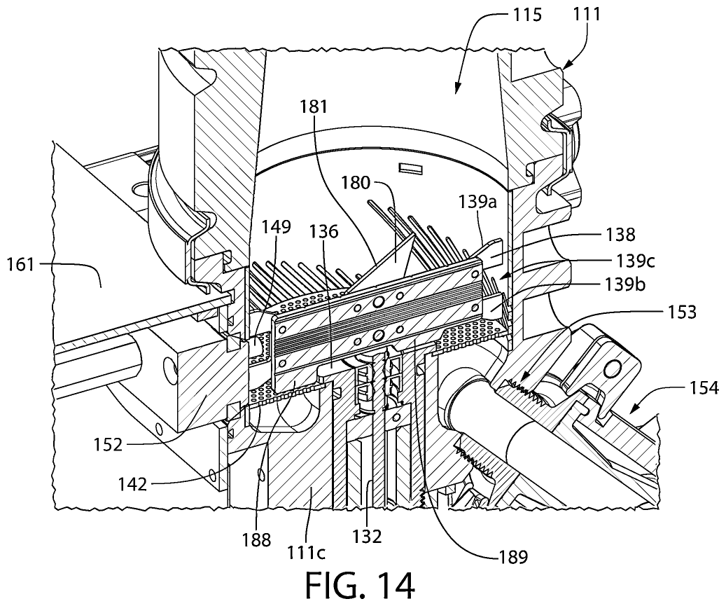

In one embodiment, each metallic end plate 138 may have a flattened U-shaped body defining an upper portion 139a, a lower portion 139b, and an outwardly open gap or concavity 139c formed between the upper and lower portions. Concavity 139c is configured to allow a knocker protrusion 149 fixedly supported inside the grinding chamber 115 to project into and pass through as the paddle 130 as it rotates (see, e.g., FIGS. 13-14). The knocker protrusion breaks down clumps of the solid sample material (e.g., soil or other) riding and being pushed along the peripheral wall 116 of the grinding chamber by the paddle. The knocker protrusion 149 advantageously intercepts and breaks down the material clump being pushed around the inside periphery of the grinding chamber, rather than allowing the clump to continue circulating around the chamber with the paddle. Knocker protrusion 149 preferably is made of a metallic material and may have any suitable shape such as without limitation cylindrical as shown, or others.

In one embodiment, knocker protrusion 149 may be fixedly mounted to the waste door 152 and is radially elongated in configuration. The knocker protrusion is therefore openable with the waste door. Opening the door with knocker protrusion 149 for cleaning out the grinding chamber 115 as further described herein helps to dislodge any debris which may have become stuck between the knocker and the stationary baseplate 142 during preparation of the slurry.

In some embodiments, paddle 130 further includes a downwardly extending scraper protrusion 188 (shown in FIGS. 13-14). The scraper protrusion is radially elongated and configured to scrape or wipe soil sample material off of baseplate 142 when paddle is rotated to mix the sample material and water. In one embodiment, scraper protrusion 188 may be formed as an integral unitary structural part of the paddle body 130e being molded at the same time therewith from the elastomeric material. A second downwardly extending scraper protrusion 189 may optionally be provided in some embodiments to scrape or wipe sample material off of the top surface of the annular flange 136 of the bearing housing 135 inside the grinding chamber 115. This second scraper protrusion 189 may also be an integral part of the elastomeric paddle body and is located inwards of the first scraper protrusion 188 on the paddle body.

Grinder-filter apparatus 110 further includes a metallic agitation blade 180 disposed in the center of the grinding chamber 115. In one embodiment, blade 180 is coupled to the top of the motor drive shaft 132 (see, e.g., FIGS. 13-14) and is rotatable therewith. Blade 180 projects upwards from drive shaft 132 above the paddle 130. The drive shaft and blade 180 are each coaxially aligned with the vertical centerline VC1 of grinder-filter apparatus 110. In one non-limiting construction, the paddle 130 may be mounted directly to the agitation blade 180, which in turn is mounted to drive shaft 132. The blade and paddle therefore rotate in unison.

Agitation blade 180 is vertically oriented and may have a flattened and angled triangular body terminated with a pointed top 182 and linear top edge which is acutely angled to vertical centerline VC1 of grinder-filter apparatus 110. In operation, agitation blade 180 breaks up clumps of soil (or other agricultural material in other embodiments) which move into the center of the grinding chamber 115 above the paddle 130 as it rotates to blend the water and soil sample material into a slurry. Any clumps or masses of sample material therefore are prevented from remaining in the center of the vortex of the slurry without being broken up by the blade. The vortex in fact formed in the slurry by paddle 130 tends to draw the congealed clumps of soil particles towards the center where they are disrupted and shattered by the rotating agitation blade 180. The paddle then forces the smaller broken down soil particles suspended in the slurry radially outwards through the slots 141a in the grinding ring 140 and into the slurry collection chamber 150, as previously described herein.

Grinder-filter apparatus 110 further includes a slurry outlet 153 which is fluidly coupled to slurry collection chamber 150 to discharge the “sized” sample slurry to the chemical analysis system 101. In one embodiment, the outlet may be formed in housing lower section 111c (see, e.g., FIGS. 12-14). As previously noted, the annular-shaped floor of slurry collection chamber 150 may be sloped downwards towards the outlet to help guide slurry out of the chamber. As can be seen in FIG. 13, for example, the floor of chamber 150 at right adjacent to slurry outlet 153 is lower than at the left. Slurry outlet 153 is configured for coupling to a slurry outlet valve 154. In one embodiment, a threaded connection between valve 154 and the slurry outlet 153 may be used as shown in the illustrated embodiment; however, other types of connections known in the fluid handling arts including flanged connections, welded connections, or other may be used.

The slurry outlet valve 154 is changeable between a closed position and open position; the latter of which places the slurry collection chamber 150 in fluid communication with the chemical analysis system directly or through intermediate flow chambers or paths. The closed position conversely fluidly isolates the collection chamber from the chemical analysis system and seals grinding chamber 115 at bottom. Any suitable type commercially-available valve having an open and closed position may be used. In one embodiment, a commercially-available air-operated pinch valve may be used as disclosed herein for the slurry outlet valve as these type valves with deformable rubber tubes are durable and operate effectively for achieving tight shutoff when handling slurries without clogging or severe wear caused by abrasive slurries. These valves are well known in the art. Other type valves me used such as diaphragm valves or others.

Referring generally to FIGS. 1-22, waste collection apparatus 160 of the present slurry preparation system is used after processing a batch of slurry in grinder-filter apparatus 110 in association with cleaning/flushing out the grinding chamber 115 with clean water to remove slurry solids residue and hard debris (e.g., stones, rocks, crop residues such as stalks, plant material, roots, etc.) before the next batch of slurry is prepared. In one embodiment, waste collection apparatus 160 defines a second vertical centerline VC2 and a vertically elongated assemblage generally including an open top support frame 161 fixedly coupled to housing 111 of the grinder-filter apparatus, a vertically-elongated open waste chute 162 fixedly mounted to and suspended from the frame, a strainer pan 166 positioned below the chute, a frustoconical funnel 164 coupled to and below the pan, and waste water discharge nozzle 165 coupled to the bottom end of the funnel. Centerline VC2 is parallel to centerline VC1 of grinder-filter apparatus 110. The support frame 161 has a perimetrically extending open picture frame type structure and includes an openable lid 168 coupled thereto on top to prevent flushing water discharged from the grinding chamber 115 during cleanout from excessively splashing out.

The top support frame 161 may have a tubular rectangular shape (with vertically open internal passageway) in one embodiment which coincides with the rectangular cuboid configuration of the chute 162 with similar rectangular cross-sectional shape. The waste chute 162 may be vertically elongated and comprises vertical walls 162a forming four sides of the chute that define the internal passageway 162b. In one embodiment, chute 162 may be formed of a resilient deformable elastomeric material such as rubber or synthetic polymeric elastomer materials. In other embodiments, however, the chute may be made of a rigid metallic or polymeric material.

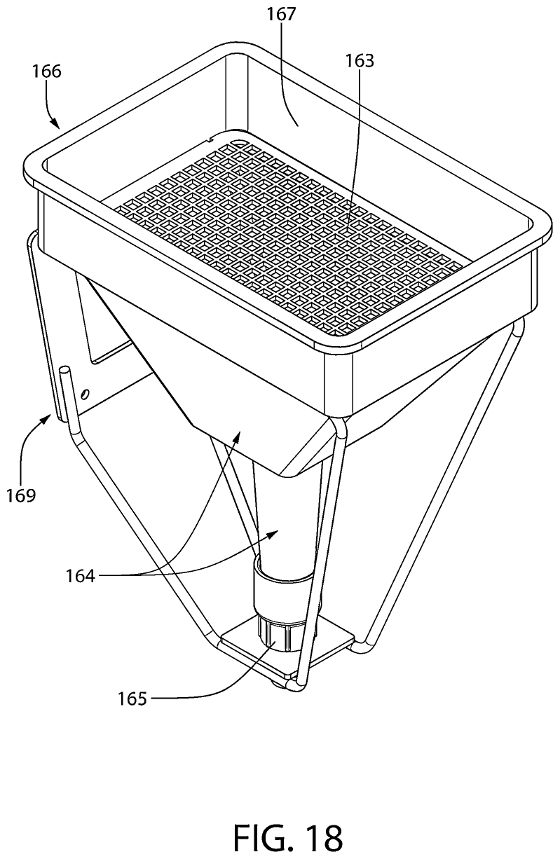

Strainer pan 166 is upwardly open and comprises four vertical sidewalls 167 complementary configured in cross-sectional shape to the chute 162. The bottom portion of the chute projects downward inside the sidewalls of the pan to prevent the flushing water from splashing out. It bears noting that there preferably is no rigid connection or coupling between the bottom of chute 162 and strainer pan 166 in one embodiment as shown. This allows the flexibly-structured chute to be deformed and pulled up and laterally out of the pan to access and manually remove debris captured by the pan. In some embodiments therefore, the strainer pan 166 and funnel 164 coupled thereto may be supported from a nearby available support surface independently of the waste chute 162 which is supported and extends downwards from the top support frame 161 affixed to the grinder-filter apparatus housing 111. Accordingly, strainer pan 166 may include a pan support bracket 169 for this purpose as shown (see, e.g., FIG. 18) configured for mounting to an available independent support surface. The bracket may also be configured to support funnel 164 at bottom and the waste water discharge nozzle 165, thereby providing a self-supported rigidly coupled assemblage.

Strainer pan 166 further includes a perforated screen 163 comprising a plurality of holes 163a which allow the flushing water with smaller solids fines to pass through, but traps the hard debris larger than a predetermined size (e.g., stones, rocks, etc.) on top of the screen. The debris may be manually removed by lifting the flexible chute 162 out of the pan as noted above, or alternatively lowering the pan to disengage the chute. In one embodiment, an orthogonal grid array of square holes 163a may be used to maximize the open areas in the screen through which the flushing water can pass into and through the funnel 164 beneath the pan. Other shapes of holes 163a however including circular may be used. The funnel 164 may be directly coupled to the bottom of strainer pan 166 to collect and concentrate or funnel the flushing water containing some smaller material fines that pass through the perforated screen 163 to the waste water discharge nozzle 165 coupled directly to the bottom of the funnel. Discharge nozzle 165 directs the flushing waste water to a suitable receptacle or drainage pipe/tube connection.

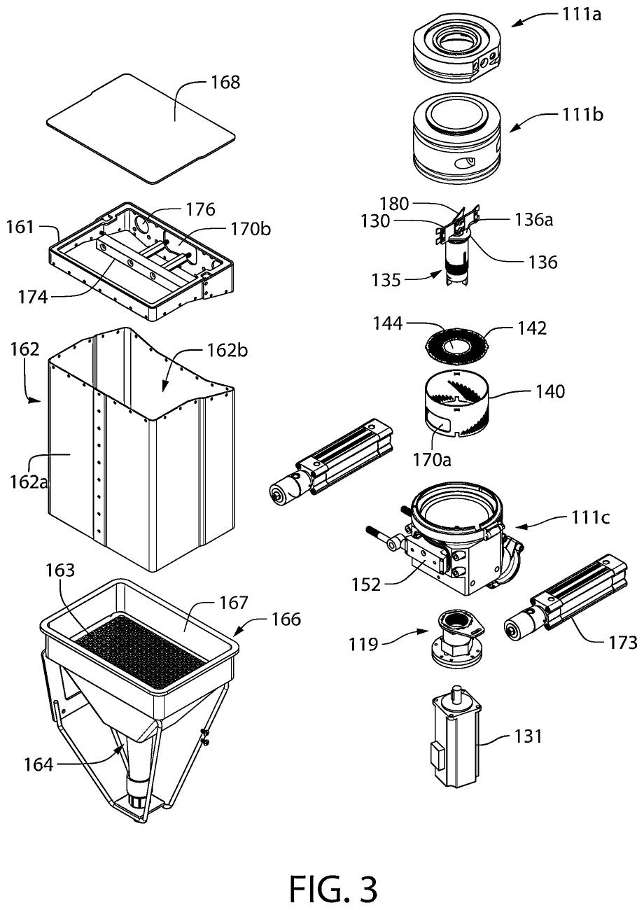

Referring particularly to FIGS. 3-4, 12-15, 18, and 20-22, waste collection apparatus 160 further includes an openable/closeable waste door 152 which is sealable to a complementary configured waste window 170 formed through the arcuately curved sidewall 112c of housing 111 of the grinding chamber 115. Waste window 170 has an arcuately curved shape and at least part of waste door 152 which fully closes the window opening therefore has a complementary configured arcuately curved portion 152a to fluidly seal the window. Waste window 170 may have a suitably large circumferential width and height to effectively flush and clean out the grinding chamber with flushing water and hard debris remaining therein after processing a batch of slurry. In one embodiment, the waste window 170 may occupy a majority of one quadrant of the grinding chamber 115 in the circumferential direction when viewed from above as shown in FIG. 15. An elastomeric seal 171 disposed around the waste window 170 on the exterior of grinder housing 111 seals the door 152 to the window opening in the housing 111 in a fluid tight manner.

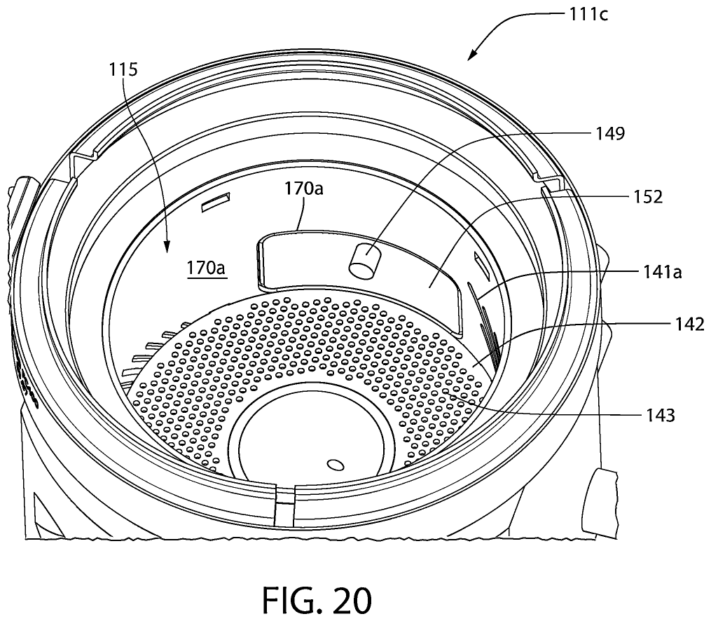

In one embodiment, waste window 170 is formed in the lower section 111c of housing adjacent to the paddle 130 and is radially aligned with a complementary configured debris opening 170a formed through the sidewall 140a of grinding ring 140 (see, e.g., FIGS. 3-4 and 16-17). The bottom edge of window 170 preferably is substantially flush with the top of the perforated baseplate 142 (see, e.g., FIGS. 13 and 20). This ensures debris and waste water in the grinding chamber 115 can be effectively flushed out into the awaiting chute 162 of the waste collection apparatus 160 with minimal residual matter left behind when the grinding chamber is flushed out periodically.

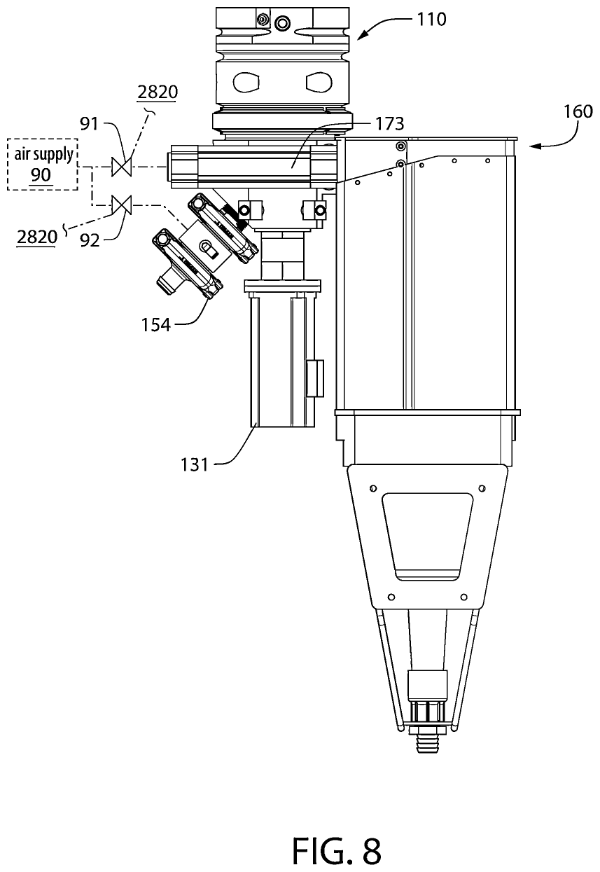

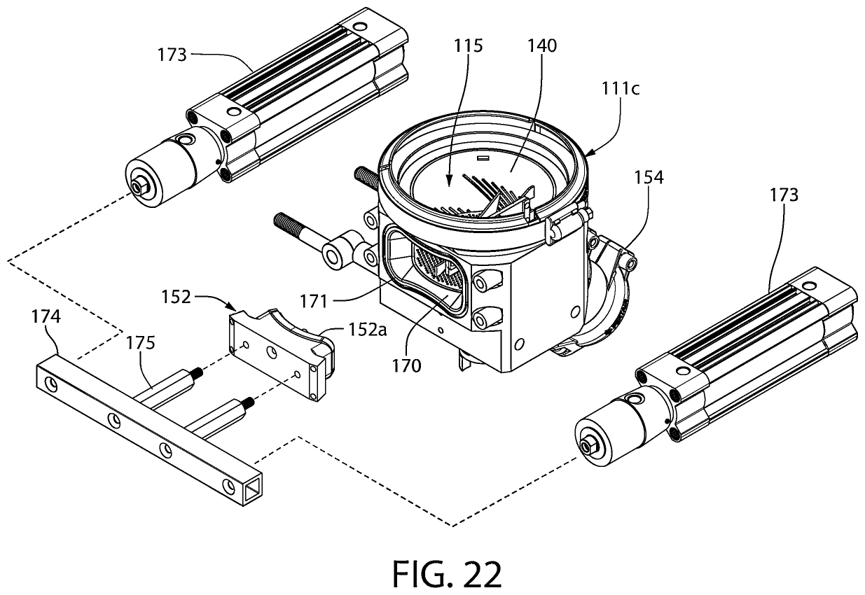

Waste door 152 in some non-limiting embodiments may be operated by a pneumatic or electric door actuator 175 operably coupled to the waste door. FIGS. 1-4, 15, and 21-22 include details of the actuator. The door actuator is operable to selectively and slideably move the waste door between the open position disengaged from the grinder-filter apparatus housing 111 and closed position engaged with and sealed to the housing. In one embodiment, door actuator 175 may include a pair of electric or pneumatic actuator cylinders 173 (pneumatic actuators are shown) to advantageously provide a balanced closing force on the waste door 170 against the housing 111 and seal 171. This provides a better liquid-tight seal of the door to the grinding chamber 115 particularly since the waste door 152 and concomitantly the corresponding waste window 170 in grinder housing 111 each have a greater width than height as shown in the non-limiting illustrated embodiment (see, e.g., FIG. 22). Any suitable commercially-available electric or pneumatic actuator may be used. If pneumatic actuators are used, a suitable pressurized air source such as compressed air from air supply system 90 shown schematically in FIG. 8 may be coupled to the actuators for actuation.

In one embodiment, actuator cylinders 173 may be supported by the waste chute top support frame 161, which in turn is fixedly mounted the grinder-filter apparatus housing 111. Support frame 161 includes a pair of openings through which the extendible operating rods 173a of the cylinders may be projected into the central opening of the frame and outwards therefrom. The support frame further includes a door opening 170b which is complementary configured with and radially aligned with waste window 170 in housing lower section 111c and debris opening 170a formed through the sidewall 140a of grinding ring 140 (see, e.g., FIGS. 3-4 and 16-17). The actuator cylinders may be horizontally oriented and fixedly mounted to frame 168 in a stationary manner.

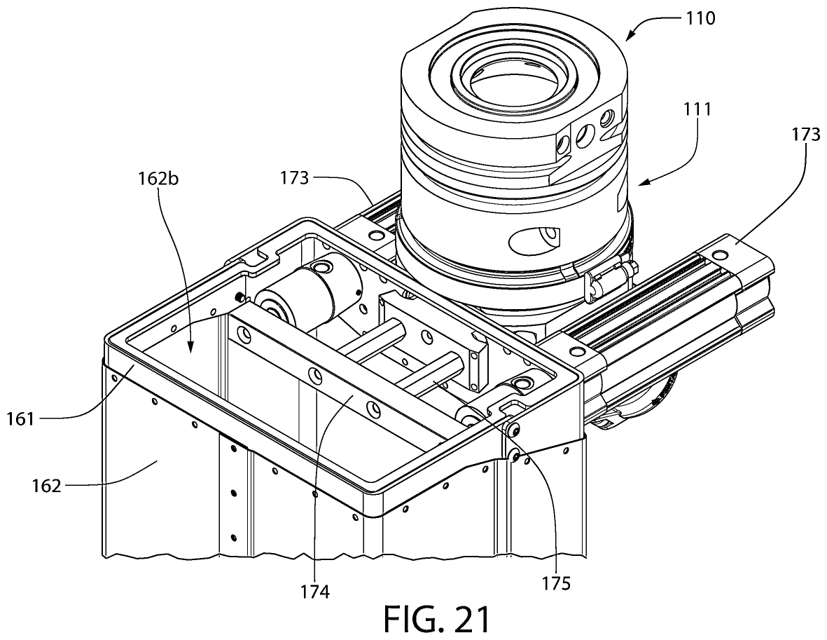

The retractable/extendible operating rods 173a of the actuator cylinders are fixedly coupled at their outer terminal ends to an elongated operating bar 174. The operating rods of each actuator are coupled to opposite end portions of the operating bar (see, e.g., FIGS. 21-22). Operating bar 174 may be horizontally oriented in a direction transversely to vertical centerline VC1 of grinder-filter apparatus 110. The operating bar is coupled to waste door 152 by a pair of tie rods 175 as shown.

In operation, extending operating rods 173a of the actuator cylinders 173 slides and moves the operating bar 174 away from grinding chamber 115. This unseats and disengages the waste door 152 from the grinder-filter apparatus housing 111 in a corresponding sliding linear path and manner away from the grinding chamber transversely (e.g., perpendicularly) to vertical centerline VC1 The grinding chamber 115 is now open to flush the chamber out with cleaning or flushing water which exits with any residual debris in the chamber through the waste window 170.

To reclose the grinding chamber, the operating rods 173a of actuator cylinders 173 are retracted. This slides operating bar 172 and waste door 152 back towards the apparatus housing 111. The door re-engages seal 171 surrounding the waste window 170 on the housing to reseal the window in preparation for preparing the next batch of soil sample slurry. It bears noting that in the illustrated embodiment, the operating bar 174 and waste door 152 each move and remain entirely within the confines of the top support frame 161 of waste collection apparatus 160 through their entire range of back and forth linear motion to open and reclose the grinding chamber 115.

A method or process for preparing an agricultural sample slurry using grinder-filter apparatus 110 will now be briefly described. In one non-limiting embodiment, the sample slurry may be prepared in batch mode with preparation of a single batch of blended and sized slurry before the next batch is prepared. This ensures that a homogenous batch of slurry is produced with consistent solid particle size meeting the predetermined maximum particle size design criteria or limits associated with the downstream chemical analysis system before slurry release from the grinding chamber 115.

Starting with slurry outlet valve 154 and waste door 152 in their closed positions, the agricultural sample material and water are added into the grinding chamber 115 through the top of the grinder housing 111. The bulk sample material is soil in this non-limiting example. The water and soil may be added to the grinding chamber in any order; however, the water may be added first to a level to preclude any small soil particles which can pass through the perforated baseplate from entering the slurry collection chamber 150 without water to avoid plugging issues. The open top 112a of the grinder housing 111 and grinding chamber 115 is then closed and sealed by moving lid 195 inwards and downwards via vertically moveable support member 197 to engage the lid with the grinder housing (i.e. upper section 111a to cover and close central top opening 117).

Next, the paddle drive motor 131 is started to rotate the paddle 130 and mix the water and sample material (e.g., soil) to form the sample slurry. The paddle and central agitation blade 118 rotating with the paddle break down the soil material into smaller particles. The water and soil are mixed for a period of time necessary to produce a homogenous slurry with even distribution of soil particles throughout. The paddle and blade may be rotated continually for the period of time, or intermittently with brief pauses between rotating cycles and/or reversal in direction for extra agitation which may be beneficial with some types of sample materials such as soils that are more resistant to shattering and crumbling into smaller particles (e.g., clay type soils). For either continuous or intermittent operating modes of the grinder-filter apparatus 110, the paddle 130 and blade 180 may be rotated at a relative high rate of speed (RPM) for mixing and sizing the sample slurry (e.g., 4000 RPM or other dependent in part upon the nature of the sample material). If the slurry is prepared and size in the continuous mode of operating via rotating the paddle, the duration of time may be about one minute as one non-limiting representative example. Longer or shorter times may be used dependent upon the type sample material being processed and the characteristics/property of the material.

In addition to breaking down or shattering the clumps of the sample material, the paddle 130 with end plates 138 at its ends force the sample slurry radially outwards towards the grinding ring 140. The end plates act to press the sample slurry against the ring and into the flow openings 141 (i.e. slots 141a) as the paddle rotates. Only soil particles less than the preselected width W1 dimension of the slots can enter the slots with the slurry. As previously described herein, the flow slots are sized to limit a predetermined maximum size of sample material particles which can pass into the flow openings of the ring. The grinding ring thus produces a “sized” sample slurry with maximum particle size meeting the size limitation.

As the slurry with entrained soil particles enters the flow slots 141a, the sized sample slurry passes into the upper portions 141b of the slots in the grinding chamber 115. The slurry flows downwards along the lengths L1 of each slot into slurry collection chamber 150. The sized sample slurry exits the lower portions 141c of the flow slots 141a beneath the perforated baseplate 142 and enters the collection chamber 150. As the paddle 130 continues to rotates, a small portion of the sized sample slurry recirculates back up into the grinding chamber 115 through the perforations in the baseplate 142 to beneficially further agitate the slurry, as previously described herein.

Once the slurry is thoroughly mixed and sized, the method or process continues with slowing the paddle down to a reduce speed (RPM), and opening the slurry outlet 153 by opening slurry outlet valve 154 to discharge the sized sample slurry and empty slurry collection chamber 150 while rotating the paddle at the reduced speed. The sized slurry flows downstream to the chemical analysis system 101.

The next step is to clean out the grinding chamber 115 using the waste collection apparatus 160 in preparation for processing the next batch of sample slurry. This generally includes introducing flushing water into the grinding chamber to agitate and loosen any remaining soil residue and ejecting the water and any remaining debris (e.g., rocks, stones, hardened clumps of sample material, wood, etc.) not broken down by the paddle 130, agitation blade 118, or knocker protrusion 149.

The grinding chamber cleanout process or method may generally include stopping the paddle 130 in one operating mode, closing the slurry outlet (i.e. outlet valve 154), opening lid 195, adding clean flushing water to the empty grinding chamber 115, closing the lid, and rotating the paddle for a period of time sufficient to loosen any soil residue, opening the waste door 152 of the grinding chamber, and discharging the flushing water with residual soil and debris remaining in the grinding chamber out through the now open waste window 170 in the grinding chamber accessed by opening the door. The paddle may be rotated at the higher rotational speed to agitate and loosen the soil residue and leftover debris (e.g., 4000 RPM or higher). Preferably, the paddle 130 may continue to be rotated when the waste door is opened to help push and eject the flushing water and debris out from the grinding chamber 115. Also preferably, the paddle 130 is rotated at a reduced speed less than the higher rotational speed used to prepare the sample material slurry discussed above (e.g., less than 4000 RPM in one non-limiting example) when the waste door is open. Because the top of the perforated baseplate 142 is substantially flush with the bottom edge of the waste window 170 as previously described herein, the slowly rotating paddle 130 will engage and forcibly push any debris off of the baseplate and out through the waste window. Any residual “dirty water” left below the base plate 142 in slurry collection chamber 150 that cannot exit the waste door above the baseplate can be removed by briefly opening and then reclosing slurry outlet valve 154 at the end of the cleaning cycle. The dirty water is diverted to waste after leaving the slurry collection chamber and outlet valve.

In an alternative operating mode of the foregoing process, the paddle 130 may continue to be rotated at the reduced speed from evacuating the sized sample slurry from slurry collection chamber 150 of grinder-filter apparatus 110 without stopping when the grinding chamber is opened and flushing water is introduced. In this case, the slurry outlet valve 154 is simply closed after the slurry collection chamber is emptied of the sized slurry and then the flushing water is added to chamber while still rotating paddle. The remaining cleanout steps described above then proceed in the manner presented.

The cleanout process or method continues with collecting the ejected flushing water with residual soil and debris exiting waste window 170 in waste chute 162, separating the hard debris from the flushing water via strainer pan 166 with perforated screen 163, collecting the strained flushing water (i.e. waste water) in funnel 164, and /discharging the flushing/waste water through waste water discharge nozzle 165 to a waste drain or other receptacle for the waste water.

Once the flushing water and debris are removed from grinding chamber 115 and slurry collection chamber 150, the waste door 152 is reclosed. The grinder-filter apparatus 110 is now ready to process the next batch.

It will be appreciated that numerous variations and order of steps or additional steps in the foregoing basic sample slurry preparation and subsequent grinder-filter apparatus cleaning process are possible. The inventive method/process is not limited in this regard.

In some embodiments, the foregoing processes/methods, and components of the grinder-filter apparatus 110 and waste collection apparatus 160 as appropriate may be operated and controlled by an automated control system 2800 including programmable main system controller 2820. Controller 2820 is operably coupled and communicably linked to the system components shown in FIG. 7. This includes, without limitation, at least the paddle drive motor 131, slurry discharge valve 154, and waste door actuator 175. In the event pneumatic actuator cylinders 173 and slurry discharge valve 154 are used, the controller 2920 is operably coupled and linked to the pneumatic air shutoff valves 91 and 92 respectively which are supplied with compressed air from a pressurized air source such as the air supply system 90 (shown schematically in dashed lines in FIG. 8). This controls the air to the cylinders and valve in an on/off mode. If electrically operated actuator cylinders and valves are used, the controller is operably coupled and linked directly to these components as shown in FIG. 7. The controller 2820 may be operably coupled to other components and devices, including sensors configured to measure flow, temperature, pressure, motion, fluid levels, and others as may be provided. The control system may be configured for bidirectional communication with all of the foregoing components, devices, and sensors.

System controller 2820 may include one or more processors, non-transitory tangible computer or machine readable medium such as memory 2805, user interface 2815, programmable input/output peripherals, and all other necessary electronic appurtenances and devices normally associated with a fully functional processor-based controller and control system. Control system 2800, including controller 2820, is operably and communicably linked to the foregoing components/devices associated with the grinder-filter apparatus 110 and waste collection apparatus 160 via suitable wired or wireless communication links 2821 to control operation of those systems and devices in a fully integrated and sequenced manner.

Computer or machine accessible and readable medium may include any suitable volatile memory and non-volatile memory or devices operably and communicably coupled to the processor(s). Any suitable combination and types of volatile or non-volatile memory may be used including as examples, without limitation, random access memory (RAM) and various types thereof, read-only memory (ROM) and various types thereof, hard disks, solid-state drives, flash memory, or other memory and devices which may be written to and/or read by the processor operably connected to the medium.

Both the volatile memory and the non-volatile memory may be used for storing the program instructions or software. In one embodiment, the computer or machine accessible and readable non-transitory medium (e.g., memory 2805) contains executable computer program instructions which when executed by the system controller 2820 cause the system components and apparatuses to perform operations or methods according to the present disclosure. While the machine accessible and readable non-transitory medium (e.g., memory 2805) is shown in an exemplary embodiment to be a single medium, the term should be taken to include a single medium or multiple media (e.g., a centralized or distributed database, and/or associated caches and servers) that store the one or more sets of control logic or instructions. The term “machine accessible and readable non-transitory medium” shall also be taken to include any medium that is capable of storing, encoding or carrying a set of instructions for execution by the machine and that cause the machine to perform any one or more of the methodologies of the present disclosure. The term “machine accessible and readable non-transitory medium” shall accordingly also be taken to include, but not be limited to, solid-state memories, optical and magnetic media, and carrier wave signals.

The user interface 2815 can be configured for direct user input such as a control panel with visual display such as a touchscreen and/or hard and/or soft (software) buttons, and wired and/or wireless bidirectional communications which may include a WLAN transceiver (e.g., WiFi), an infrared transceiver, a Bluetooth transceiver, Ethernet, Near Field Communications, combinations thereof, or other suitable communication interfaces and protocols for communications with other electronic processor-based devices such as cellphones, tablets, laptops, desktop computers, etc. which may be used to program and communicate with the controller 2820.

The agricultural sample slurry preparation system including grinder-filter apparatus 110 and waste collection system including waste collection apparatus 160 disclosed herein is usable with and may form part of an overall agricultural sampling and analysis systems, such as but not limited to those described in U.S. Patent Application Publication No. 2018/0124992A1 and PCT Publication No. WO020/012369, and other systems are described in U.S. Application Nos. 62/983,237, filed on 28 Feb. 2020; 63/017,789, filed on 30 Apr. 2020; 63/017,840, filed on 30 Apr. 2020; 63/018,120, filed on 30 Apr. 2020; 63/018,153, filed on 30 Apr. 2020; 63/191,159, filed on 20 May 2021; 63/191,166, filed on 20 May 2021; 63/191,172, filed on 20 May 2021; Ser. No. 17/326,050, filed on 20 May 2021; 63/191,186, filed on 20 May 2021; 63/191,189, filed on 20 May 2021; 63/191,195, filed on 20 May 2021; 63/191,199, filed on 20 May 2021; 63/191,204, filed on 20 May 2021; Ser. No. 17/343,434, filed on 9 Jun. 2021; 63/208,865, filed on 9 Jun. 2021; Ser. No. 17/343,536, filed on 9 Jun. 2021; 63/213,319, filed on 22 Jun. 2021; 63/260,772 filed on 31 Aug. 2021; 63/260,776 filed on 31 Aug. 2021; 63/260,777 filed on 31 Aug. 2021, 63/245,278 filed on 17 Sep. 2021; 63/264,059 filed on 15 Nov. 2021; 63/264,062 filed on 15 Nov. 2021; and 63/264,065 filed on 15 Nov. 2021; and PCT Application Nos. PCT/IB2021/051076, filed on 10 Feb. 2021; PCT/IB2021/051077, filed on 10 Feb. 2021; PCT/IB2021/052872, filed on 7 Apr. 2021; PCT/IB2021/052874, filed on 7 Apr. 2021; PCT/IB2021/052875, filed on 7 Apr. 2021; and PCT/IB2021/052876, filed on 7 Apr. 2021.

As an example, the present grinder-filter apparatus 110 may be substituted for the two-part separate mixer and coarse filter shown in FIG. 35 of U.S. application Ser. No. 17/326,050 filed 20 May 2021; 63/191,186 filed 20 May 2021; 63/191,189 filed 20 May 2021; 63/191,195 filed 20 May 2021; 63/191,199 filed 20 May 2021; and 63/191,204 filed 20 May 2021. Advantageously, the grinder-filter apparatus replaces the mix and filter, and the associated valving and interconnecting flow conduits between these two components with a single compact unit which both grinds the agricultural sample material in preparation of the sample slurry and filters/strains the resultant slurry to meet the maximum particle size limits previously described herein.

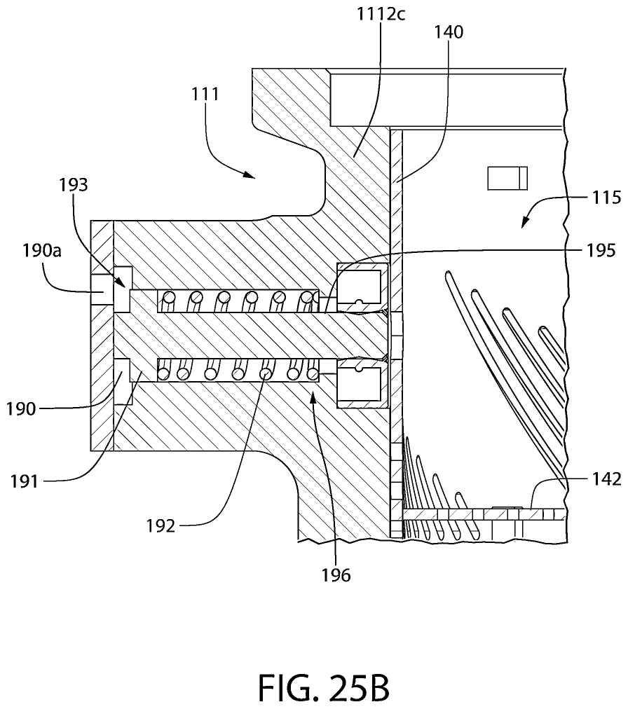

FIGS. 25A and 25B show an alternative embodiment of a knocker protrusion previously described herein. In the present embodiment, a knocker protrusion 195 may be provided which is movably mounted to a wall of the grinding chamber 115 in lieu of fixedly mounted to the waste door 152. The alternative knocker protrusion is thus radially projectible into and retractable from the grinding chamber 115 independently of opening and closing the waste door. In one embodiment, knocker protrusion 195 may have an elongated cylindrical solid body and functions similarly to knocker protrusion 149 previously described herein.

In one embodiment, knocker protrusion 195 may be slideably received and disposed in a radial bore 190 formed in a portion of the arcuately curved sidewall 112c of housing 111 of the grinding chamber 115. Knocker protrusion 149 is movable between an inward actuated position projected into the grinding chamber 115 from the bore and sidewall 112c (see, e.g., FIG. 25B), and an outward unactuated position retracted from the grinding chamber inside the bore and sidewall (FIG. 25A).

In one embodiment, knocker protrusion 195 may be operated by a pneumatic air operator 193 formed integrally with the grinder housing sidewall 112c as shown. Bore 190 may be fluidly coupled to a pressurized air source via an air supply opening 190a in the grinder sidewall, such as without limitation air supply system 90 (see, e.g., FIG. 8). A spring 192 disposed in bore 190 biases the knocker protrusion towards the retracted unactuated position. Knocker protrusion 195 may include an annular flange 191 which engages one end of spring 192. The opposite end of the spring may be engage a stepped-shaped annular edge 196 formed within the bore proximate to the grinding chamber 115. Spring 192 may be a helical compression spring in one non-limiting embodiment; however, other types of springs and arrangements may be used to bias the knocker protrusion 195 outwards away from the grinding chamber. In the present operating scheme, air is applied to knocker protrusion 195 to maintain its projected position. When air pressure is removed, the spring returns the knocker protrusion back outwards.

Movable knocker protrusion 195 functions similar to knocker protrusion 149 to intercept and break down any hardened sample material clumps being pushed around the inside periphery of the grinding chamber by paddle 130. Whereas knock protrusion 149 is fixedly attached to and openable with waste door 152 when flushing out the grinding chamber 115, present knocker protrusion 195 may be retracted from the grinding chamber during the flushing operation to ensure no debris or hardened clumps remains lodged within the chamber which is not flushed out the waste door. When the waste door is closed and the grinding chamber 115 is ready to resume operation, the knocker protrusion may be returned to it projected position.

### EXAMPLES

The following are nonlimiting examples.

Example 1—a grinder-filter apparatus for preparing an agricultural sample slurry comprising: an outer housing defining a vertical centerline and a sealable internal grinding chamber configured to receive agricultural sample material and water; a paddle rotatably disposed in the chamber and operable to mix the sample material and water to form the sample slurry; an annular grinding ring extending circumferentially around a peripheral wall of the grinding chamber, the grinding ring including an array of flow openings spaced circumferentially around the grinding ring; a baseplate disposed in a lower portion of the grinding chamber inside the grinding ring; wherein the paddle when rotated is operable to force the sample material and water radially outwards into the flow openings of grinding ring, and the flow openings are configured to pass sample material particles of a predetermined size in the slurry into a slurry collection chamber of the apparatus.

Example 2—the grinder-filter apparatus according to Example 1, wherein the collection chamber is located beneath the baseplate proximate to the grinding chamber.

Example 3—the grinder-filter apparatus according to Example 2, wherein the baseplate is circular and comprises a plurality of perforations extending through the baseplate between the collection chamber and the grinding chamber, the collection chamber being in fluid communication with the grinding chamber through the perforations.

Example 4—the grinder-filter apparatus according to any one of Examples 1 to 4, wherein the flow openings of the grinding ring comprise elongated slots each extending vertically above the baseplate for a distance into the grinding chamber and below the baseplate for a distance into the collection chamber.

Example 5—the grinder-filter apparatus according to Example 4, wherein the slots comprise a plurality of different lengths.

Example 6—the grinder-filter apparatus according to Examples 4 or 5, wherein the slots are angled in a direction of a rotation of the paddle.

Example 7—the grinder-filter apparatus according to Example 1, wherein the paddle is horizontally elongated in a direction transverse to the vertical centerline of the grinding chamber and comprises opposing first and second ends each of which terminate proximate to the grinding ring.

Example 8—the grinder-filter apparatus according to Example 7, wherein the paddle comprises a flat body formed of a resiliently deformable material bendable about the vertical centerline.

Example 9—the grinder-filter apparatus according to Examples 7 or 8, wherein the body of the paddle is structurally reinforced with strands of cording fiber embedded in the paddle, the strands of cording fiber each extending horizontally between the first and second ends of the paddle and operable to limit radial elongation of the paddle when rotated.

Example 10—the grinder-filter apparatus according to Example 9, wherein the strands of cording fiber comprise Kevlar® cords.

Example 11—the grinder-filter apparatus according to any one of Examples 7 to 10, wherein each of the first and second ends of the paddle have a rigid metallic end plate coupled to each end, the end plates each defining a vertical edge which travels along and adjacent to the grinding ring when the paddle is rotated to push the sample material into the flow openings of the grinding ring.

Example 12—the grinder-filter apparatus according to Example 11, wherein each end plate has a U-shape defining an upper portion, a lower portion, and an outwardly open concavity formed between the upper and lower portions.

Example 13—the grinder-filter apparatus according to Example 12, further comprising a knocker protrusion fixedly supported inside the grinding chamber, the knocker protrusion being passable through the concavity of each end plate when the paddle is rotated to break down clumps of the sample material riding along the peripheral wall of the grinding chamber.

Example 14—the grinder-filter apparatus according to Example 1, further comprising a paddle drive motor comprising a rotating drive shaft which rotates the paddle, the drive shaft coaxially aligned with the vertical centerline of the housing.

Example 15—the grinder-filter apparatus according to Example 14, further comprising a metallic agitation blade coupled to the drive shaft above the paddle.

Example 16—the grinder-filter apparatus according to Example 1, wherein the housing further comprises a sealable waste door which forms a part of the peripheral wall of the grinding chamber, the waste door changeable between a closed position which seals the grinding chamber for grinding the sample material, and an open position which provides access to the grinding chamber for cleaning out debris with flushing water which cannot be broken down.

Example 17—the grinder-filter apparatus according to Example 16, further comprising a pneumatic or electric door actuator coupled to the waste door, the door actuator operable to slideably move the waste door between the open and closed positions.

Example 18—the grinder-filter apparatus according to Examples 17 or 18, further comprising a waste collection apparatus disposed adjacent to the grinder-filter apparatus and configured to receive and separate the flushing water and debris.

Example 19—the grinder-filter apparatus according to Example 18, wherein the waste collection apparatus comprises a waste chute arranged to receive the flushing water and debris from a waste window formed in the grinding chamber, a strainer pan coupled to the waste chute and comprising a plurality of perforations configured to separate the debris from the flushing water, and a funnel which receives the flushing water from the strainer pan.

Example 20—the grinder-filter apparatus according to Example 1, wherein the collection chamber has an annular shape, and further comprising a slurry outlet fluidly coupled to the collection chamber beneath the baseplate for discharging the sample slurry.

Example 21—the grinder-filter apparatus according to Example 3, wherein the baseplate is elevated above and supported from a floor of the collection chamber by a plurality of standoffs.

Example 22—the grinder-filter apparatus according to Example 1, further comprising a movable lid configured to detachably seal a top of the grinding chamber.

Example 23—the grinder-filter apparatus according to any one of Examples 1 to 22, wherein the sample material is soil.

Example 24—the grinder-filter apparatus according to Example 16, further comprising a knocker protrusion fixedly coupled to the waste door, the knocker protrusion projecting radially into the grinding chamber and being openable and closeable with the waste door.

Example 25—The grinder-filter apparatus according to Example 1, further comprising a knocker protrusion movably coupled to a portion of the outer housing of the grinder-filter apparatus, the knocker protrusion being radially projectible into and retractable from the grinding chamber independently of opening and closing the waste door.

Example 26—The grinder-filter apparatus according to Example 25, wherein the knocker protrusion is movable between an inward actuated position projected into the grinding chamber from the outer housing, and an outward unactuated position retracted from the grinding chamber inside the outer housing.

Example 27—The grinder-filter apparatus according to Example 26, wherein the knocker protrusion is slideably disposed in a bore formed in the outer housing.

Example 28—The grinder-filter apparatus according to Example 27, wherein the knocker protrusion air-operated and further comprising a spring disposed in the bore which biases the knocker protrusion outwards towards the unactuated position.

Example 29—a method for preparing an agricultural sample slurry, the method comprising: providing a grinder-filter apparatus comprising a vertical centerline and grinding chamber; adding water and agricultural sample material into the grinding chamber; sealing the grinding chamber; rotating a paddle to mix the water and sample material to form the sample slurry; forcing the sample slurry radially outwards with the paddle; pressing the sample slurry into flow openings in a grinding ring with the paddle, the flow openings being sized to limit a maximum size of sample material particles which can pass into the flow openings to create a sized sample slurry; and passing the sized sample slurry along the flow openings into a slurry collection chamber.

Example 30—the method according to Example 29, wherein grinding ring has an annular cylindrical body and extends circumferentially around a peripheral wall of the grinding chamber.

Example 31—the method according to Example 30, wherein the flow holes comprise a plurality of vertical elongated slots which move the sized sample slurry downwards along a length of the slots into a slurry collection chamber.

Example 32—the method according to Example 31, wherein the pressing step comprises pushing the slurry against the grinding ring and into the slots with flattened metallic end plates coupled to opposite terminal ends of the paddle.

Example 33—the method according to Example 32, wherein the paddle has a horizontally elongated body formed of a resiliently deformable material and rotates around the vertical centerline of the grinder-filter apparatus.

Example 34—the method according to Example 29, wherein the slurry collection chamber is located beneath a perforated baseplate disposed inside the grinding ring, and further comprising recirculating a portion of the sized sample slurry back into the grinding chamber through the perforated baseplate.

Example 35—the method according to any one of Examples 29-34, further comprising steps of slowing the paddle down to a reduced speed, and opening a slurry outlet valve to discharge the sized sample slurry from and empty the slurry collection chamber while rotating the paddle at the reduced speed.

Example 36—the method according to Example 35, further comprising steps of: closing the slurry outlet valve; adding flushing water to the empty slurry collection chamber while the paddle continues to rotate at the reduced speed; opening a waste door coupled to the grinding chamber; and discharging the flushing water and debris remaining in the grinding chamber out through a waste window in the grinding chamber opened by the waste door.

Example 37—the method according to Example 36, further comprising steps of collecting the flushing water and debris with a waste chute; separating the debris from the flushing water; and discharging the flushing water without debris to waste.

While the foregoing description and drawings represent some example systems, it will be understood that various additions, modifications and substitutions may be made therein without departing from the spirit and scope and range of equivalents of the accompanying claims. In particular, it will be clear to those skilled in the art that embodiments of the present disclosure may be embodied in other forms, structures, arrangements, proportions, sizes, and with other elements, materials, and components, without departing from the spirit or essential characteristics thereof. In addition, numerous variations in the methods/processes described herein may be made. One skilled in the art will further appreciate that the embodiments of the present disclosure may be used with many modifications of structure, arrangement, proportions, sizes, materials, and components and otherwise, used in the practice of the embodiments of the present disclosure, which are particularly adapted to specific environments and operative requirements without departing from the principles of the present embodiments of the present disclosure. The presently disclosed embodiments are therefore to be considered in all respects as illustrative and not restrictive, the scope of the embodiments of the present disclosure being defined by the appended claims and equivalents thereof, and not limited to the foregoing description or embodiments. Rather, the appended claims should be construed broadly, to include other variants and embodiments, which may be made by those skilled in the art without departing from the scope and range of equivalents of the embodiments of the present disclosure.

1. A grinder-filter apparatus for preparing an agricultural sample slurry comprising:
an outer housing defining a vertical centerline and a sealable internal grinding chamber configured to receive agricultural sample material and water;
a paddle rotatably disposed in the chamber and operable to mix the sample material and water to form the sample slurry;
an annular grinding ring extending circumferentially around a peripheral wall of the grinding chamber, the grinding ring including an array of flow openings spaced circumferentially around the grinding ring;
a baseplate disposed in a lower portion of the grinding chamber inside the grinding ring;
wherein the paddle when rotated is operable to force the sample material and water radially outwards into the flow openings of grinding ring, and the flow openings are configured to pass sample material particles of a predetermined size in the slurry into a slurry collection chamber of the apparatus.

2. The grinder-filter apparatus according to claim 1, wherein the collection chamber is located beneath the baseplate proximate to the grinding chamber.

3. The grinder-filter apparatus according to claim 2, wherein the baseplate is circular and comprises a plurality of perforations extending through the baseplate between the collection chamber and the grinding chamber, the collection chamber being in fluid communication with the grinding chamber through the perforations.

4. The grinder-filter apparatus according to claim 1, wherein the flow openings of the grinding ring comprise elongated slots each extending vertically above the baseplate for a distance into the grinding chamber and below the baseplate for a distance into the collection chamber.

5. The grinder-filter apparatus according to claim 4, wherein the slots comprise a plurality of different lengths.

6. The grinder-filter apparatus according to claim 4, wherein the slots are angled in a direction of a rotation of the paddle.

7. The grinder-filter apparatus according to claim 1, wherein the paddle is horizontally elongated in a direction transverse to the vertical centerline of the grinding chamber and comprises opposing first and second ends each of which terminate proximate to the grinding ring.

8. The grinder-filter apparatus according to claim 7, wherein the paddle comprises a flat body formed of a resiliently deformable material bendable about the vertical centerline.

9. The grinder-filter apparatus according to claim 7, wherein the body of the paddle is structurally reinforced with strands of cording fiber embedded in the paddle, the strands of cording fiber each extending horizontally between the first and second ends of the paddle and operable to limit radial elongation of the paddle when rotated.

10. The grinder-filter apparatus according to claim 9, wherein the strands of cording fiber comprise Kevlar® cords.

11. The grinder-filter apparatus according to claim 7, wherein each of the first and second ends of the paddle have a rigid metallic end plate coupled to each end, the end plates each defining a vertical edge which travels along and adjacent to the grinding ring when the paddle is rotated to push the sample material into the flow openings of the grinding ring.

12. The grinder-filter apparatus according to claim 11, wherein each end plate has a U-shape defining an upper portion, a lower portion, and an outwardly open concavity formed between the upper and lower portions.

13. The grinder-filter apparatus according to claim 12, further comprising a knocker protrusion fixedly supported inside the grinding chamber, the knocker protrusion being passable through the concavity of each end plate when the paddle is rotated to break down clumps of the sample material riding along the peripheral wall of the grinding chamber.

14. The grinder-filter apparatus according to claim 1, further comprising a paddle drive motor comprising a rotating drive shaft which rotates the paddle, the drive shaft coaxially aligned with the vertical centerline of the housing.

15. The grinder-filter apparatus according to claim 14, further comprising a metallic agitation blade coupled to the drive shaft above the paddle.

16. The grinder-filter apparatus according to claim 1, wherein the housing further comprises a sealable waste door which forms a part of the peripheral wall of the grinding chamber, the waste door changeable between a closed position which seals the grinding chamber for grinding the sample material, and an open position which provides access to the grinding chamber for cleaning out debris with flushing water which cannot be broken down.

17. The grinder-filter apparatus according to claim 16, further comprising a pneumatic or electric door actuator coupled to the waste door, the door actuator operable to slideably move the waste door between the open and closed positions.

18. The grinder-filter apparatus according to claim 16, further comprising a waste collection apparatus disposed adjacent to the grinder-filter apparatus and configured to receive and separate the flushing water and debris.

19. The grinder-filter apparatus according to claim 18, wherein the waste collection apparatus comprises a waste chute arranged to receive the flushing water and debris from a waste window formed in the grinding chamber, a strainer pan coupled to the waste chute and comprising a plurality of perforations configured to separate the debris from the flushing water, and a funnel which receives the flushing water from the strainer pan.

20. The grinder-filter apparatus according to claim 1, wherein the collection chamber has an annular shape, and further comprising a slurry outlet fluidly coupled to the collection chamber beneath the baseplate for discharging the sample slurry.

21. The grinder-filter apparatus according to claim 3, wherein the baseplate is elevated above and supported from a floor of the collection chamber by a plurality of standoffs.

22. The grinder-filter apparatus according to claim 1, further comprising a movable lid configured to detachably seal a top of the grinding chamber.

23. The grinder-filter apparatus according to claim 1, wherein the sample material is soil.

24. The grinder-filter apparatus according to claim 16, further comprising a knocker protrusion fixedly coupled to the waste door, the knocker protrusion projecting radially into the grinding chamber and being openable and closeable with the waste door.

25. The grinder-filter apparatus according to claim 1, further comprising a knocker protrusion movably coupled to a portion of the outer housing of the grinder-filter apparatus, the knocker protrusion being radially projectible into and retractable from the grinding chamber independently of opening and closing the waste door.

26. The grinder-filter apparatus according to claim 25, wherein the knocker protrusion is movable between an inward actuated position projected into the grinding chamber from the outer housing, and an outward unactuated position retracted from the grinding chamber inside the outer housing.

27. The grinder-filter apparatus according to claim 26, wherein the knocker protrusion is slideably disposed in a bore formed in the outer housing.

28. The grinder-filter apparatus according to claim 27, wherein the knocker protrusion is air-operated and further comprising a spring disposed in the bore which biases the knocker protrusion outwards towards the unactuated position.

29. A method for preparing an agricultural sample slurry, the method comprising: providing a grinder-filter apparatus comprising a vertical centerline and grinding chamber; adding water and agricultural sample material into the grinding chamber; sealing the grinding chamber; rotating a paddle to mix the water and sample material to form the sample slurry; forcing the sample slurry radially outwards with the paddle; pressing the sample slurry into flow openings in a grinding ring with the paddle, the flow openings being sized to limit a maximum size of sample material particles which can pass into the flow openings to create a sized sample slurry; and passing the sized sample slurry along the flow openings into a slurry collection chamber.

30. The method according to claim 29, wherein grinding ring has an annular cylindrical body and extends circumferentially around a peripheral wall of the grinding chamber.

31. The method according to claim 30, wherein the flow holes comprise a plurality of vertical elongated slots which move the sized sample slurry downwards along a length of the slots into a slurry collection chamber.

32. The method according to claim 31, wherein the pressing step comprises pushing the slurry against the grinding ring and into the slots with flattened metallic end plates coupled to opposite terminal ends of the paddle.

33. The method according to claim 32, wherein the paddle has a horizontally elongated body formed of a resiliently deformable material and rotates around the vertical centerline of the grinder-filter apparatus.

34. The method according to claim 29, wherein the slurry collection chamber is located beneath a perforated baseplate disposed inside the grinding ring, and further comprising recirculating a portion of the sized sample slurry back into the grinding chamber through the perforated baseplate.

35. The method according to claim 29, further comprising steps of slowing the paddle down to a reduced speed, and opening a slurry outlet valve to discharge the sized sample slurry from and empty the slurry collection chamber while rotating the paddle at the reduced speed.

36. The method according to claim 35, further comprising steps of: closing the slurry outlet valve; adding flushing water to the empty slurry collection chamber while the paddle continues to rotate at the reduced speed; opening a waste door coupled to the grinding chamber; and discharging the flushing water and debris remaining in the grinding chamber out through a waste window in the grinding chamber opened by the waste door.

37. The method according to claim 36, further comprising steps of: collecting the flushing water and debris with a waste chute; separating the debris from the flushing water; and discharging the flushing water without debris to waste.
